(19) United States
(12) Patent Application Publication
(10) Pub. No.: US 2023/0241558 A1
(43) Pub. Date: Aug. 3, 2023

(54) Graphene Oxide-Nanoparticle Composite Membranes, Preparation and Uses Thereof

(71) Applicant: KYOTO UNIVERSITY, Kyoto (JP)

(72) Inventors: Easan Sivaniah, Kyoto-shi (JP); Behnam Ghalei, Kyoto-shi (JP); Guoji Huang, Kyoto-shi (JP)

(21) Appl. No.: 18/007,795

(22) PCT Filed: Jan. 29, 2021
(86) PCT No.: PCT/IB2021/050708

§ 371 Date: Dec. 2, 2022

(51) Int. Cl. B01D 71/02; B01D 53/22; B01D 69/12; B01D 69/10; C01B 3/50

(52) U.S. Cl. CPC B01D 71/0211; B01D 53/228; B01D 69/12; B01D 69/107; B01D 69/108; C01B 3/503; B01D 2256/16; C01B 2210/0012; B82Y 30/00

(57) ABSTRACT

Provided is a porous composite membrane including graphene oxide sheets; nanoparticles bound to a surface of the graphene oxide sheets solely by electrostatic and/or Van der Waals interactions. The present invention also relates to a method of producing the porous composite membrane, a gas separation system including the porous composite membrane, and uses of the porous composite membrane in a process for separating H₂ from a gas stream and a process for reducing H₂O swelling in a graphene oxide-based membrane.

### CROSS REFERENCE TO RELATED APPLICATIONS

This application is the United States national phase of International Application No. PCT/IB2021/050708 filed Jan. 29, 2021 and claims priority to U.S. patent application Ser. No. 16/892,666 filed on Jun. 4, 2020, the disclosures of which are hereby incorporated by reference in their entireties.

### BACKGROUND OF THE INVENTION

### Field of the Invention

The present invention relates to graphene oxide-based porous composite membranes with an improved stability to humidity and resistance to water-swelling, a method of producing the same and uses thereof notably in gas separation systems and processes for separating H₂ from a gas stream.

In the present document, the numbers between brackets ({ }) refer to the List of References provided at the end of the document.

### Description of Related Art

Graphene oxide (GO), which is cheaply sourced through controlled oxidation and exfoliation of graphite, has recently emerged as a promising 2D nanomaterial to make high-performance membranes for important applications. GO has long been known for its ability to form ultra-permeable hydrogen membranes with high selectivity (α) to hydrogen (H₂) against many gases including carbon dioxide. In the early 2010's, ultrathin graphene oxide (GO) was proposed as a step-change material for the separation of hydrogen and carbon dioxide via membrane separation processes. Selectivities of up to 1000 and triple-digit (˜000 GPU) permeances were reported. These capabilities are ideal for highly efficient H₂ separation, to reach purity levels required for immediate use in fuel cells.

However, GO is also highly hygroscopic, and has a natural tendency to swell in the presence of humidity, that is, absorb water into the GO channel and form an enlarged interlayer spacing (d-spacing). As such, GO films are highly hygroscopic and swell in the presence of humidity, catastrophically losing sieving capability. When the GO membranes are exposed to a humid environment, the hydrated GO sheets become negatively charged and will come apart due to the electrostatic repulsion in which promotes the GO membranes delamination. As such, the water swelling severely impairs the separation capability of layer-stacked GO membranes. Such catastrophic swelling is the Achilles heel of GO membranes, presenting an un-resolved obstacle to the practical implementation of this exciting technology.

The foregoing shows that there is an unmet need for GO-based membranes with improved stability to humidity and resistance to water-swelling; and for a method of imparting water stability and improved resistance to water-swelling to GO-based membranes.

### SUMMARY OF THE INVENTION

Thus it is an object of the invention to provide a GO-based membrane with improved stability to humidity and resistance to water-swelling.

Improving upon known GO-based membranes it is proposed according to the invention a porous composite membrane comprising:
graphene oxide sheets; and
nanoparticles bound to a surface of the graphene oxide sheets solely by electrostatic and/or Van der Waals interactions.

The present invention also provides a method of manufacturing a porous composite membrane according to the invention, comprising the steps of:
(i) providing a dispersion of graphene oxide sheets in an aqueous solvent;
(ii) providing a dispersion of nanoparticles in an aqueous solvent;
(iii) mixing the graphene oxide dispersion and the nanoparticle dispersion to form a dispersion of graphene oxide-nanoparticle composite; and
(iv) filtering the dispersion obtained in step (iii) through a porous support substrate to form a substrate-supported graphene oxide-nanoparticle composite membrane.

In another aspect, the present invention also provides a gas separation system comprising a porous composite membrane in fluidic communication with a gas stream containing a mixture of at least two separable gases including H₂, wherein the porous composite membrane comprises:
graphene oxide sheets; and
nanoparticles bound to a surface of the graphene oxide sheets solely by electrostatic and/or Van der Waals interactions.

In yet another aspect, the present invention provides a process for separating H₂ from a gas stream, comprising a step of permeating a mixture of at least two separable gases through a porous composite membrane of claim 1, wherein the gas mixture comprises at least H₂.

In still another aspect, the present invention also provides a process for reducing H₂O swelling in a graphene oxide-based membrane comprising associating nanoparticles in electrostatically and/or Van der Waals binding interaction with graphene oxide sheets constituting the graphene oxide-based hydrogen membrane.

### BRIEF DESCRIPTION OF THE DRAWINGS

Throughout the Drawings, data illustrated for pristine GO membranes and GO-based composite membranes with negatively charged nanoparticles (e.g., ND⁻, POSS⁻) are provided as comparative data, whereas data relative to GO-based composite membranes with positively charged nanoparticles (e.g., ND⁺, POSS⁺) are provided to illustrate exemplary embodiments of the invention.

FIGS. 1A-1K provide information about the observed microstructure of GO-based composite membranes according to the invention. FIG. 1A. Schematic view of GOαND⁺ composite structures for efficient separation of H₂ from CO₂. i. Stacking of GO nanosheets as orderly laminate membranes, ii. The introduction of ND⁺s into GO structure leads to less ordered stacking of GO sheets, iii. The GO sheets swell by adsorbing water, which deteriorates the microstructure of the membrane, iv. ND⁺s retain the microstructure of GOαND⁺ at humid conditions, and v. The molecular depiction of electrostatic intermolecular interactions between GO sheets and ND⁺ particles. Carbon atoms are shown in filled gray markers; Oxygen and hydrogen atoms are in grid markers and open markers, respectively. FIG. 1B-1 AFM image of a GO sheet. The inset shows the height profile of the GO sheet. FIG. 1B-2 AFM image of GO30ND⁺. The inset shows the height profile of GO sheets with ND⁺s. FIG. 1C. TEM image of ND⁺ particles deposited on GO at 30% ND⁺ loading; scale bar is 50 nm. FIG. 1D. The particle-to-particle distance of ND⁺s decorating GO surface at 30% ND loading. FIG. 1E. Cross-section TEM image of GO and ND⁺ interface in GO30ND⁺ membrane; scale bar is 10 nm. FIGS. 1F-G. Surface and cross-sectional FESEM images of vacuum-filtered GO membranes; Inset shows the surface SEM of AAO support; scale bar is 200 nm for both FIGS. 1F-G. FIGS. 1H-1I. surface and cross-sectional SEM of vacuum-filtered GO30ND⁺ membranes; scale bars are 200 nm. FIG. 1J. The normalized H₂ permeance and FIG. 1K. the normalized H₂/CO₂ separation factor of GO and GOαND⁺ membranes versus time under equimolar hydrated (RH:85%) equimolar H₂: CO₂ mixture.

FIGS. 2A-2F depict observed lateral size of GO sheets. SEM image (FIGS. 2A-2C) and the corresponding size distribution (FIG. 2D-2F) estimated by Image J software with taking the square root of the area of SGO (FIGS. 2A and 2D), GO (FIGS. 2B and 2E) and LGO (FIGS. 2C and 2F). Three types of GO sheets with average lateral sizes of 0.2, 3 and 10 μm were synthesized. The average lateral size of the GO sheets was obtained by scanning electron microscopy (SEM) images and the corresponding size distributions are estimated by Image J software from more than 120 sheets. For preparing AFM samples, 1 μg/ml of SGO, GO and LGO dispersions were dropped on the surface of silicon wafer and air dried for 24 h.

FIGS. 3A-3B provide information about the observed size distribution of ND⁺ particles. Dynamic light scattering of 5 mg/mL of ND⁺s dispersion in water, showing a diameter of about 3 nm (FIG. 3A), which is consistent with the data obtained from the TEM images (FIG. 3B). The scale bar is 5 nm in the TEM image.

FIGS. 4A-4C provide information about the observed size distribution of negatively charged ND (ND⁻) used in Comparative Example 2 (FIG. 4A), and negatively and positively charged POSS particles used in Comparative Example 3 and Example 4, respectively (FIGS. 4B and 4C, respectively). All the samples were measured by Dynamic light scattering of 5 mg/mL dispersions in water. The dispersed negatively charged POSS (POSS⁻) particles show an average size of ˜4 nm in water (FIG. 4B), which is similar with ND-s (FIG. 4A). The positively charged POSS (POSS⁺) exhibited an average size of ˜7 nm (FIG. 4C).

FIG. 5 depicts digital images of a GO membrane (part a) and GOαND⁺ composite membranes: GO10ND⁺ (part b), GO20ND⁺ (part c) and GO30ND⁺ (part d) membranes. All GOαND⁺ composite membranes show relatively high transparency, indicating the good dispersion of ND⁺ inside the GO framework.

FIGS. 6A-6H depict 2D and 3D height AFM images of GO-based membranes surface. GO membrane (FIGS. 6A-B), GO10ND⁺ membrane (FIGS. 6C-D), GO20ND⁺ membrane (FIGS. 6E-F) and GO30ND⁺ membrane (FIGS. 6G-H). The scan area is 10 μm×10 μm. The related surface roughness parameters are presented in Table 1.

FIGS. 7A-7D depict surface SEM images of GO based membranes. GO (FIG. 7A), GO10ND⁺ (FIG. 7B), GO20ND⁺ (FIG. 7C) and GO30ND⁺ (FIG. 7D). The inset figure is the SEM image of bare AAO support. The surface microstructure is gradually turned to rough morphology when the ND⁺ particles are added. The presence rough microstructure without any significant agglomeration of ND⁺ particles confirmed the uniform dispersion of ND⁺ particles, even at relatively high loading of 30 wt %.

FIGS. 8A-8D depict comparative long-term separation of equimolar H₂/CO₂ mixture through the GO based membranes under humid condition (RH: 85%) at room temperature between GO-based membranes according to the invention and GO-POSS composite membranes of comparative Example 2. FIG. 8 shows the H₂ permeance of GOαND⁺ (FIG. 8A) and GOαPOSS⁻ (FIG. 8B) composite membranes, and the H₂/CO₂ selectivity of GOαND⁺ (FIG. 8C) and GOαPOSS⁻ (FIG. 8D) composite membranes, under continuous feed of equimolar H₂/CO₂ mixture under humid condition (RH: 85%).

FIGS. 9A-9H provide information on physicochemical properties of GO-based membranes. FIG. 9A Zeta potential values of GO, GOαND⁺, GOαND⁻, GOαPOSS⁺ and GOαPOSS⁻ composites at different loadings at pH 7; The inset shows the zeta potential values of ND^{+/-} and POSS^{+/-} dispersions at pH 7. FIG. 9B XRD patterns of GOαND⁺ membranes with different loadings of ND⁺ particles. FIG. 9C H₂ permeance and H₂/CO₂ ideal selectivity of GO and GO30ND⁺ with different thicknesses. FIG. 9D H₂/CO₂ separation performance of GO-ND⁺ composite membranes according to the invention (circles, the numbers indicate the ND⁺ content in the membranes) in comparison with the state-of-the-art GO-based H₂ separation membranes known in the art (squares). 1: {1}, 2: {2}, 3: {3}, 4: {4}, 5: {5}, 6: {6}, 7: {7}, 8: {8}, 9: {9}, 10: {10}, 11: {11}, 12: {12}, 13: {13}; The inset shows the changes in the H₂ separation performance of the membranes by adding various types of nanofillers (i.e. ND⁺ and POSS⁻ at different loadings) FIG. 9E. H₂/CO₂ separation performance of GO-ND⁺ composite membranes according to the invention (circles, the numbers indicate the ND⁺ content in the membranes) compared with the state-of-the-art H₂ separation membranes other than GO-based materials. COFs (pentagon): [14]; Inorganics (diamonds): 1: {15}, 2: {16}, 3: {17}, 4: {18}, 5: {19}, 6: {20}; MXene (hexagon): {21}; MOFs (triangles): 1: {22}, 2: {23}, 3: {24}, 4: {25}, 5: {26}, 6: {24}, 7: {27}, 8: {28}, 9: {29}, 10: {30}, 11: {31}. FIGS. 9F-G. H₂ permeance and H₂/CO₂ selectivity of the composite membranes comprising various types of nanofillers (i.e. ND^{+/-} and POSS^{+/-}) at different loadings under equimolar H₂/CO₂ mixture feed. FIG. 9H. H₂ (black circles) and CO₂ (black triangles) permeances of GO30ND⁺ membranes (left y-axis) and the H₂/CO₂ selectivity (hollow squares) obtained from mixed gas feeds of CO₂ with different H₂ contents (right y-axis).

FIG. 10 depicts FTIR spectra of ND⁺ particles, GO and GOαND⁺ composite membranes. GO exhibited typical peaks corresponding to C—O (alkoxy/alkoxide, 1046 cm⁻¹), C—O (carboxy, 1410 cm⁻¹), C═C (aromatic, 1627 cm⁻¹), C═O (carboxy/carbonyl, 1726 cm⁻¹) and —OH (3300 cm⁻¹). While the ND⁺spectrum shows the related absorption peaks at 1720 and 1000-1350 cm⁻¹ are corresponding to stretching of C═O and C—O or C—O—C vibrations, respectively, which is consistent with the literature. The carbonyl band at 1726 cm⁻¹ shifted to lower frequencies to a broad peak at 1636 cm⁻¹ by incorporation of ND⁺ particles, evidencing the hydrogen bonds between GO and ND⁺s.

FIGS. 11A-11C show comparative XPS analysis of GO (FIG. 11A) and GO30ND⁺ (FIGS. 11B-C) membranes. The XPS of GO30ND⁺ membrane showed a decrease in O/C ratio compared with GO sample. Also, a significant decline in the intensity of C═O compared to GO membrane was observed (see Table 4). This might be due to the hydrogen bonding between the oxygen-containing groups on the surface of GO sheets and ND⁺ particles. No nitrogen peak was found in GO membranes, whereas the GO30ND⁺ membrane exhibited 1.5% nitrogen, detected at 399.1 eV (C—NH—C) and 401.1 eV (C3-N).

FIG. 12 shows Raman spectra of ND⁺, GO and GOαND⁺ composite membranes. The D and G peaks at around 1345 cm-1 and 1590 cm⁻¹ are characteristics of defective graphitic carbon and sp2 hybridized aromatic carbon in pure GO membrane. The ID/IG for GO and GOαND⁺ membranes are quite similar. However, for GOαND⁺ membranes, D and G bonds are slightly broader than that of pristine GO, confirming the disordered structure due to the intercalation of ND⁺ and GO sheets. By adding ND⁺s, the D and G peaks are slightly shifted and reached to lower ˜1342 cm⁻¹ and higher ˜1591 cm⁻¹ for GO30ND⁺ which we surmise may be due to the electrostatic interactions between the GO and ND⁺s.

FIG. 13 shows comparative mechanical properties of GO-based composite membranes according to the invention versus a pure GO-based membrane and a GOαPOSS⁻ composite membrane. The hardness (vertical bars) and Young's modulus (squares) of the GOαND⁺ membranes improved up to 100 MPa and 25% in comparison to pure GO membrane, indicating the good interaction between GO and ND⁺. However, the nanoindentation mechanical properties of GOαPOSS⁻ composites were reduced compared with pure GO membranes, mainly due to the formation of aggregates and poor interaction with the GO framework. Error bars represent the standard error of 20 indents.

FIGS. 14A-14C depict comparative gas sorption isotherms. N₂ sorption isotherms at 77K for GO and GO30ND⁺ membranes (FIG. 14A); CO₂, H₂ and N₂ sorption isotherms at 298K for GO membrane (FIG. 14B) and GO30ND⁺ membrane (FIG. 14C). Both GO and GO30ND⁺ membranes exhibited preferential CO₂ adsorption over H₂ and N₂. Notably, the CO₂ adsorption of GO30ND⁺ is much higher than that of the pure GO membrane, which confirms that the ND⁺ particles effectively restrain the restacking of GO sheets.

FIGS. 15A-15K show comparative stability data of ND⁺ incorporated GO membranes. FIG. 15A Photographs of GO and GO30ND⁺ membranes immersed in water: i. Polyethersulfone (PES) support; ii. As-prepared GO membrane; iii. GO membrane immersed in water after 1 day; iv. As-prepared GO30ND⁺ membranes; and v. GO30ND⁺ membrane immersed in water after 1 day. Scale bar is 2 cm. FIG. 15B The normalized H₂/CO₂ (open symbols) separation factors and the normalized H₂ permeance (filled symbols) of the GO (square), GO5ND⁺ (diamond), GO10ND⁺ (circle), GO20ND⁺ (up-pointing triangle) and GO30ND⁺ (down-pointing triangle) membranes under continuous six humidity (85% RH)/dry (0% RH) cycles and equimolar H₂/CO₂ mixed gas feed. FIGS. 15C-D XRD patterns of GO and GO30ND⁺ membranes at dry condition, after exposure to humidity (RH: 33%; RH: 85%) and after immersion in water. FIGS. 15E-F Surface and cross-section FESEM images of GO membranes after humidity/dry cyclic measurements. FIG. 15G H₂ permeance loss in GO and GOαND⁺ membranes with different ND⁺ loadings under different relative humidity feeds (RH:12, 33, 75 and 85%) with respect to dry feed values; The inset presents the H₂/CO₂ selectivity values. FIG. 15H H₂/CO₂ selectivity loss of GO and GOαND⁺ membranes (with different loadings) under different relative humidity feeds (RH: 12, 33, 75 and 85%) with respect to dry feed values; The inset presents the H₂ permeance values in GPU. FIG. 15I. H₂ (top graph, upside down solid triangle), O₂ (second graph from the top, upright solid triangle) permeance of GO30ND⁺ and H₂/O₂ separation factor of the GO (open square) and GO30ND⁺ (open triangle), membranes under six continuous humidity (85% RH)/dry (0% RH) cycles and equimolar H₂/CO₂ mixed gas feed. FIG. 15J. H₂ permeance and H₂/CO₂ selectivity loss in GO, GO30ND⁺, GO30ND⁻, GO30POSS⁺ and GO30POSS⁻ membranes under humid feed (RH: 85%) with respect to dry feed values. FIG. 15K. The PM0.3 rejection values of polyethersulfone support, GO and GOαND⁺ membranes before and after immersion in water for 2 to 8 h.

FIGS. 16A-16B depict comparative FTIR (FIG. 16A) and XRD patterns (FIG. 16B) of POSS⁻ particles, GO and GOαPOSS⁻ membranes. POSS⁻ particles showed the absorption peaks at 1107 cm⁻¹ attributed to the stretching of Si—O vibrational bands. The peaks of GO mixed POSS⁻ membranes are almost unchanged compared with the ones attributed to the pure components (FIG. 16A). The XRD peak shifted to the left by the addition of POSS⁻ particle, indicating an increase in the interlayer spacing of GO sheets (FIG. 16B). The insertion of negatively charged POSS particles between the GO sheets enhanced the interlayer electrostatic repulsion and consequently broaden the channel size. The crystalline structure of GOαPOSS⁻ membranes were determined by wide-angle X-ray diffraction analysis (WAXD, RigakuRINT XRD). The samples were scanned at the rate of 10°/min over a 29 range of 5-40° using a Cu Kα anode under a voltage of 40 kV and a current of 200 mA.

FIG. 17 depicts an exemplary surface SEM image of a GO20POSS⁻ membrane (Comparative Example 2). The agglomeration of the particles within the GO system can be seen from the SEM image, indicating the poor interaction between POSS⁻ and GO sheets.

FIG. 18 shows stability data of GOαPOSS⁻ membranes. H₂/CO₂ separation factors (open markers) and H₂ permeance (filled markers) of the GO, GO10POSS⁻ and GO30POSS⁻ membranes under continuous humidity (RH: 85%)/Dry (RH: 0%) cycles using equimolar H₂/CO₂ mixture.

FIG. 19 depicts an exemplary schematic apparatus of Wicke-Kallenbach permeation system for gas separation measurements. MFC: Mass flow controller. GC: Gas chromatograph (Shimadzu GC-2014) with a thermal conductivity detector (TCD).

FIGS. 20A-20D depict TEM observation and particle-to-particle distance of ND particles decorating GO surface. FIGS. 20A and 20C: 10 wt % ND⁺s on GO sheet, FIGS. 20B and 20D: 20 wt % ND⁺s on GO sheet; scale bar 50 nm for both FIGS. 20A and 20B. The ND⁺ particles and GO-ND complexes were reexamined under TEM, using samples subjected to the same process conditions followed to prepare laminate membranes (e.g., concentration, shaking/sonication). When the ND⁺s and GO sheets were mixed and shaken, the ND⁺s decorated the GO surfaces homogeneously (FIGS. 20A-B). Based on a software-assisted image analysis, we found that above 50% of the particles are distanced from each other by 10 to 40 nm, reaching up to 120 nm (FIGS. 20C-D).

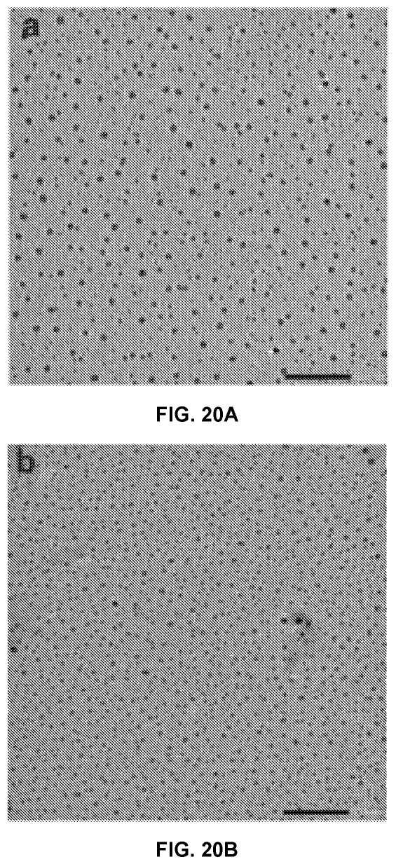

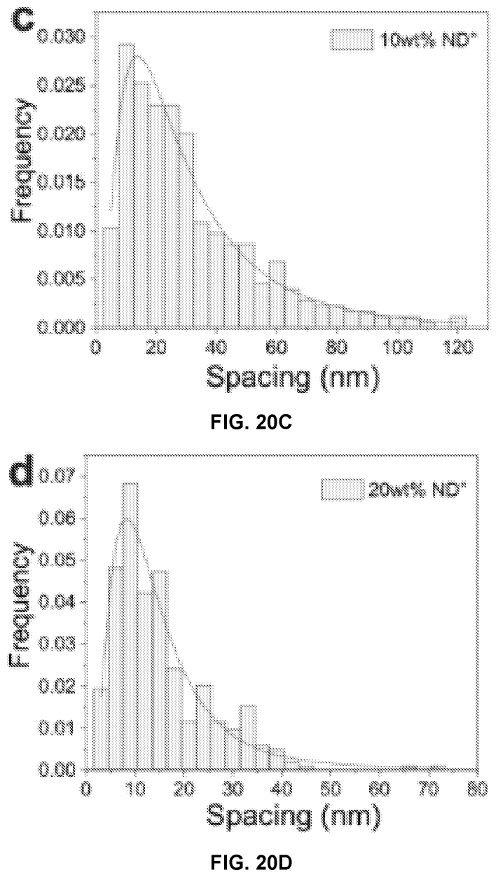

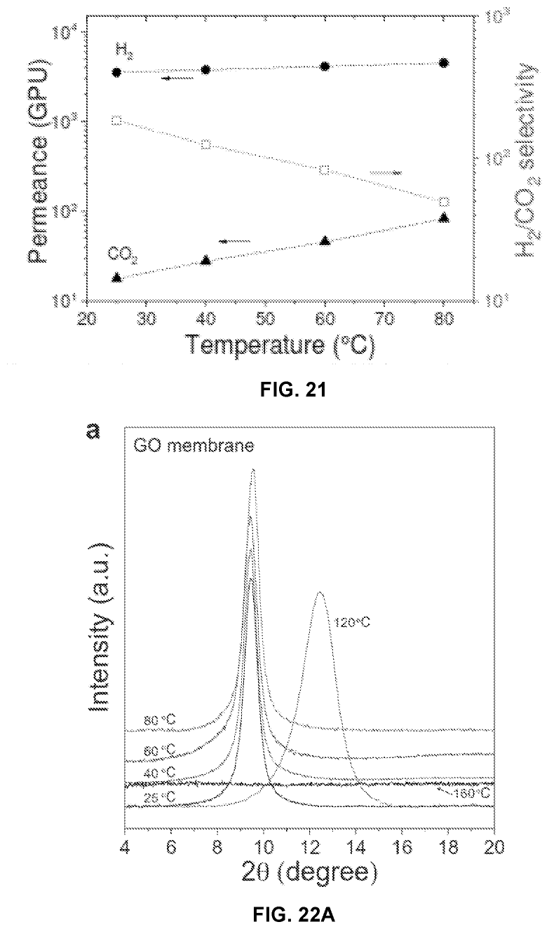

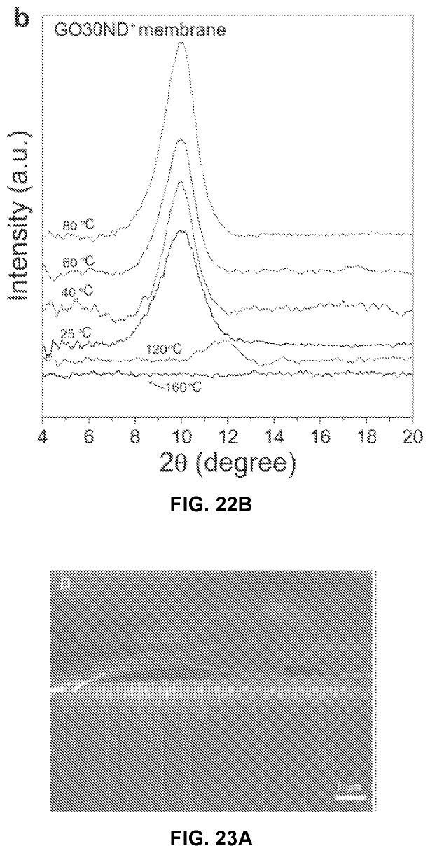

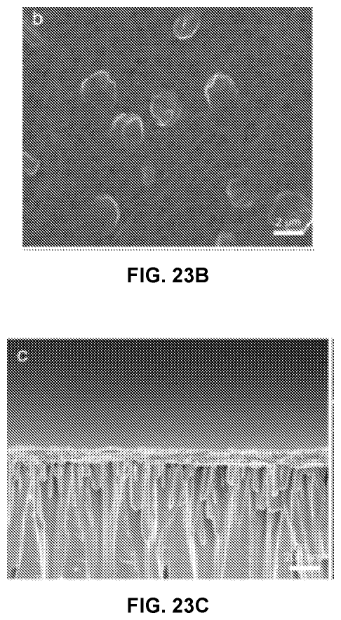

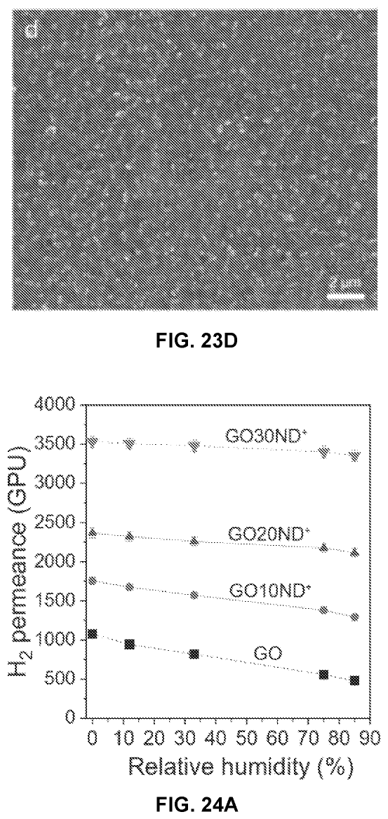

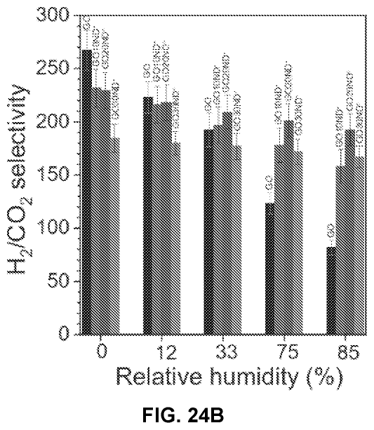

Note to FIG. 20: The distribution of ND⁺ on GO was analyzed by measuring the diameter of approximately 250 ND⁺ particles. The selection of ND⁺ was determined by the threshold of a certain TEM image grey level. The resulting values were plotted in a histogram and fitted with a Gaussian function.

The dispersion D was calculated according to a reported protocol based on TEM images¹. First, 10×10 equal distance horizontal and vertical grid lines were overlayed onto the TEM images. Then, the free path spacing between adjacent ND⁺s were accurately measured. The number of measurements N was about 200 for each sample. Next, these values were plotted into a histogram and fit with lognormal distribution function.

$$f ( x ) = \{ \begin{matrix}\frac{1}{xn \sqrt{2 π}} {e}^{- \frac{1}{2} {( \frac{l n x - m}{n} )}^{2}} ( x > 0 ) \\ 0 ( x \leq 0 )\end{matrix}$$

The dispersion D was calculated using the following equation:

$$D = {\int }_{a}^{b} \frac{1}{x n \sqrt{2 π}} {e}^{- \frac{1}{2} {( \frac{l n x - m}{n} )}^{2}} d x$$

Where x is the size of the free path spacing:

$$n = \sqrt{ln \frac{{μ}^{2} + {σ}^{2}}{{μ}^{2}}} m = ln \frac{{μ}^{2}}{\sqrt{{μ}^{2} + {σ}^{2}}}$$

where μ and σ are the mean and standard deviation, respectively.

In the range of μ±0.1μ, the dispersion D_{0.1} is

$${D}_{0.1} = {\int }_{0.9 μ}^{1.1 μ} \frac{1}{x n \sqrt{2 π}} {e}^{- \frac{1}{2} {( \frac{l n x - m}{n} )}^{2}} d x$$

In the range of μ±0.2μ, the dispersion D_{0.2} is

$${D}_{0.2} = {\int }_{0.8 μ}^{1.2 μ} \frac{1}{x n \sqrt{2 π}} {e}^{- \frac{1}{2} {( \frac{l n x - m}{n} )}^{2}} d x$$

Higher values of D_{0.1} and D_{0.2} indicate more spacing data falling into the range of μ±0.1μ and μ±0.2μ, respectively, which means more uniform distribution of the ND⁺ particles.

TABLE 9

| ND⁺ wt % | μ | σ | D_{0.1}(%) | D_{0.2}(%) |
|---|---|---|---|---|
| 10 | 34.17 | 31.22 | 9.52 | 19.27 |
| 20 | 15.21 | 10.93 | 11.98 | 23.93 |
| 30 | 56.09 | 81.83 | 6.34 | 12.88 |

FIG. 21 shows gas permeation of GO30ND⁺ membrane versus temperature at equimolar H₂/CO₂ feed gas. This figure shows the effect of temperature on the H₂/CO₂ separation performance of GO30ND membranes and is measured at dry conditions. The temperature dependence of CO₂ permeance is higher than that of H₂ permeance. As the temperature increases, the adsorption of CO₂ molecules is hindered significantly. Given the adsorption of CO₂ molecules poses a restriction for their transport through the GO membranes channels, CO₂ flux becomes higher at high temperatures, fold-wise: ˜4.7 times for CO₂ (˜17.7 to ˜82.7 GPU). However, the H₂ molecules exhibit almost no affinity to GO surfaces, resulting in H₂: ˜1.3 times (˜3532.5 to ˜4497.0 GPU). Permeance (GPU) is shown in solid symbols (filled circles and triangles), and H₂/CO₂ selectivity is shown in open squares.

FIGS. 22A-22B show XRD patterns of heat-treated (FIG. 22A) GO-only and (FIG. 22B) GO30ND⁺ membranes. The GO membrane showed a slight decreased interlayer spacing, while the interlayer spacing values of GO30ND⁺ membrane remain unchanged at 80° C., both are turned to reduction at 120° C. These results consist with an increase in the permeance and decay in the selectivity of the membranes as the temperature is increased.

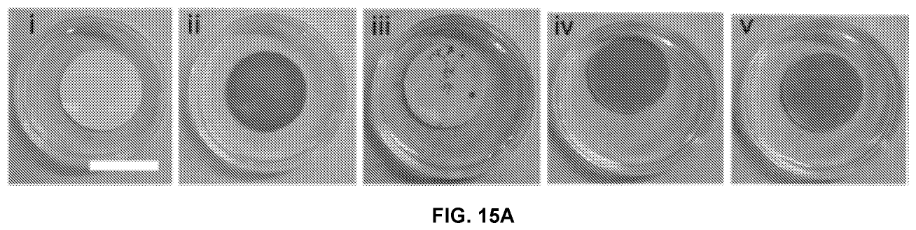

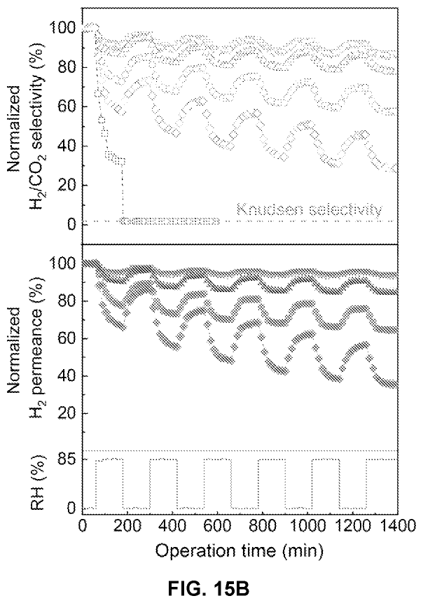

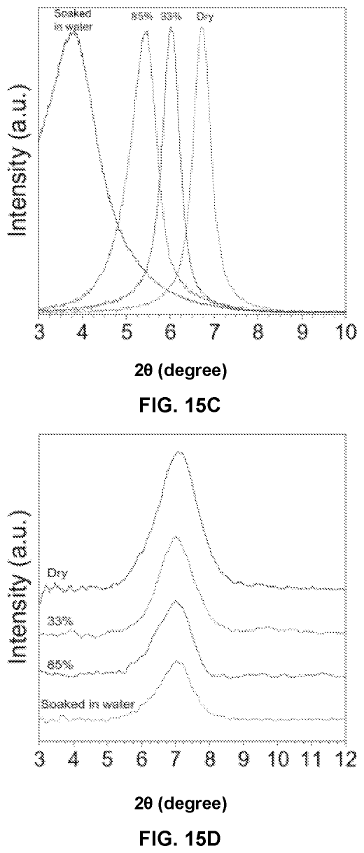

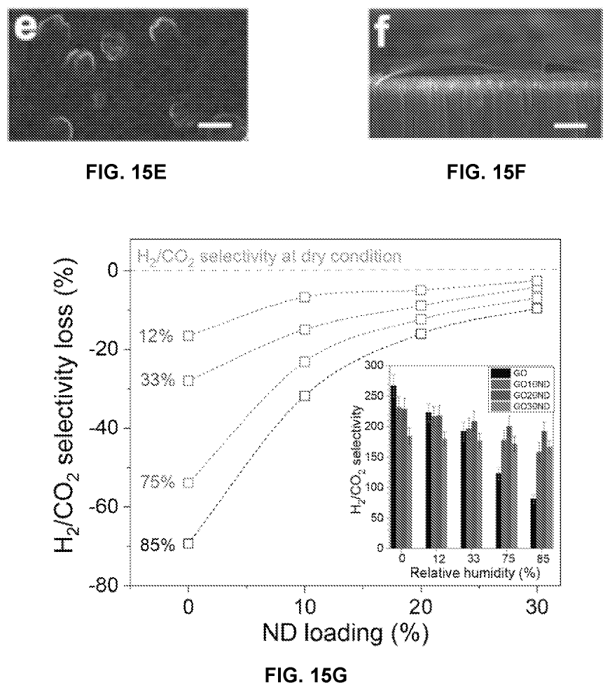

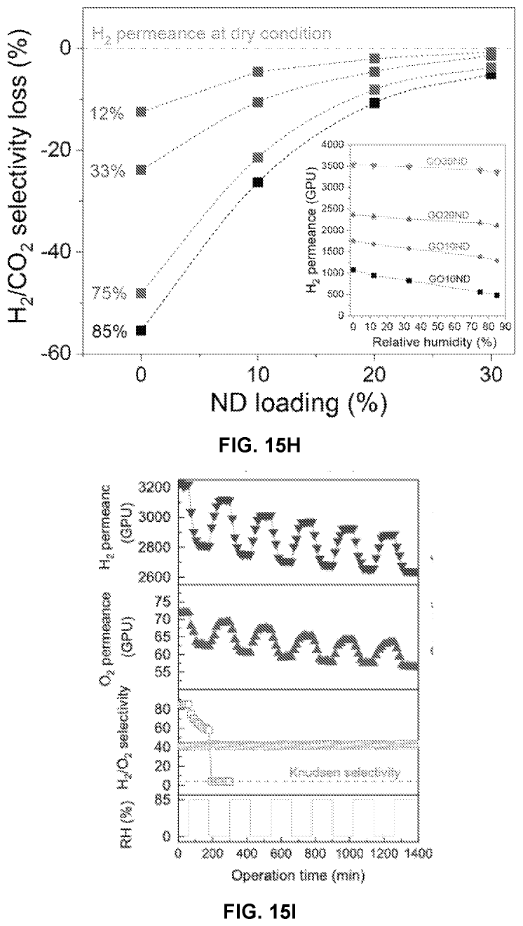

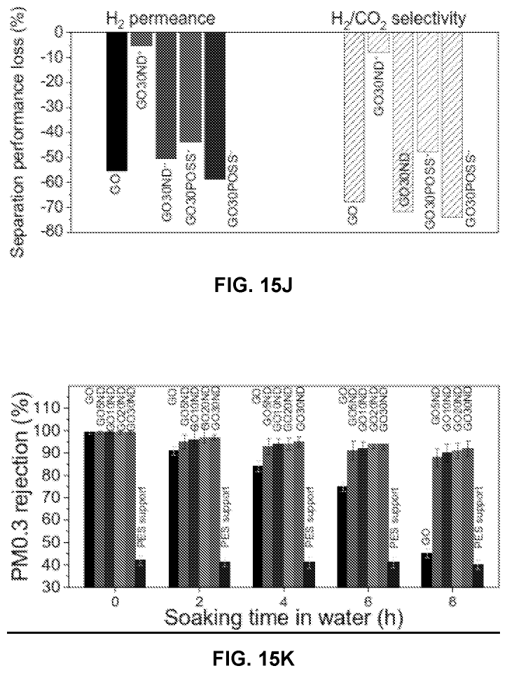

FIGS. 23A-23D show the effect of cyclic humidity test on the morphologies of (FIGS. 23A-B) GO-only and (FIGS. 23C-D) GO30ND⁺ membranes. To visualize the nature of the undesirable restructuring of GO membranes under humidity, we compared the morphologies of GO and GO30ND⁺ membranes after the cyclic humidity tests. The GO membranes start to swell and delaminate from the support (FIG. 23A). Specifically, we observe small (˜200 nm) and circular protrusions on GO membranes after the cyclic humidity test (FIG. 23B), which ends up with catastrophic failure after a certain point. For the case of the GO30ND⁺ membrane, neither delamination nor protrusions are observed (FIGS. 23C-D). Note that FIGS. 23A and 23B are the same as FIGS. 15F and 15E, respectively. The figures are provided as FIGS. 23A and 23B as well to show the difference with the SEM images of GO30ND⁺ membranes after cyclic measurements.

FIGS. 24A-24B show the H₂ permeance (FIG. 24A) and H₂/CO₂ selectivity (FIG. 24B) of GO and GOαND⁺ membranes (with different loadings) under different relative humidity feeds (RH: 12, 33, 75 and 85%).

### DEFINITIONS

Unless defined otherwise, all the technical and scientific terms used herein have the same meaning as those generally understood by one of ordinary skill in the art to which the invention pertains. Generally, the nomenclature used herein and the experiment methods, which will be described below, are those well-known and commonly employed in the art.

To facilitate an understanding of the present invention, a number of terms and phrases are defined below:

As used herein other than the claims, the terms “a,” “an,” “the,” and/or “said” means one or more. As used herein in the claims, when used in conjunction with the words “comprise,” “comprises” and/or “comprising,” the words “a,” “an,” “the,” and/or “said” may mean one or more than one. As used herein and in the claims, the terms “having,” “has,” “is,” “have,” “including,” “includes,” and/or “include” has the same meaning as “comprising,” “comprises,” and “comprise.” As used herein and in the claims “another” may mean at least a second or more.

The phrase “a combination thereof” “a mixture thereof” and such like following a listing, the use of “and/or” as part of a listing, a listing in a table, the use of “etc.” as part of a listing, the phrase “such as,” and/or a listing within brackets with “e.g.,” or i.e., refers to any combination (e.g., any sub-set) of a set of listed components, and combinations and/or mixtures of related species and/or embodiments described herein though not directly placed in such a listing are also contemplated. Such related and/or like genera(s), sub-genera(s), specie(s), and/or embodiment(s) described herein are contemplated both in the form of an individual component that may be claimed, as well as a mixture and/or a combination that may be described in the claims as “at least one selected from,” “a mixture thereof” and/or “a combination thereof.”

The term “graphene oxide” as used herein does not deviate from the conventional meaning of the term in the art and refers to the exfoliation product of graphite oxide. It refers to a compound comprising carbon, oxygen, and hydrogen in suitable ratios, and the graphene oxide may include carbon as main component constituting greater than about 50 wt %, greater than about 60 wt %, greater than about 70 wt %, greater than about 80 wt %, greater than about 90 wt %, greater than about 95 wt %, or greater than about 99 wt % of the total weight of the graphene oxide. Graphene oxide may include functional groups containing oxygen, such as epoxy, hydroxyl, or carboxyl groups.

Graphene oxide for use in the context of the invention may be made by any means known in the art. For example, graphene oxide may be obtained by oxidizing graphene (a carbon material suitably in the form of a single, planar, two-dimensional, and honey-comb like lattice). For example, graphite oxide can be prepared from graphite flakes (e.g. natural graphite flakes) by treating them with potassium permanganate and sodium nitrate in concentrated sulphuric acid. This method is called Hummers method. Another method is the Brodie method, which involves adding potassium chlorate (KClO₃) to a slurry of graphite in fuming nitric acid. Individual graphene oxide (GO) sheets can then be exfoliated by dissolving graphite oxide in water or other polar solvents with the help of ultrasound, and bulk residues can then be removed by centrifugation and optionally a dialysis step to remove additional salts.

The term “nanodiamond” as used herein refers to a diamond or a particle thereof having a size in nanometer scale, for example, having a size (e.g. cross-sectional dimension) less than about 999 nm, less than about 900 nm, less than about 800 nm, less than about, less than about 700 nm, less than about 600 nm, less than about 500 nm, less than about 400 nm, less than about 300 nm, less than about 200 nm, less than about 100 nm, or less than about 50 nm. The nanodiamond is not particularly limited in its shape, color, grade, composition, chemical modification formed thereon, or the like. In addition, the nanodiamond may include carbon as a main component constituting, for example, greater than about 50 wt %, greater than about 60 wt %, greater than about 70 wt %, greater than about 80 wt %, greater than about 90 wt %, greater than about 95 wt %, or greater than about 99 wt % of the total weight thereof. An exemplary embodiment of the present invention provides a composite comprising graphene oxide and at least one nanodiamond. In particular, the nanodiamond may be non-covalently bonded on a surface of the graphene oxide. For instance, the nanodiamond may be bonded on the surface of the graphene oxide via comprise electrostatic and/or Van der Waals interactions.

As used herein, “zeta potential” when referring to GO flake or particle surface charge does not deviate from the conventional meaning of the term in electrochemistry and refers to the potential difference between the GO flake or particle surface and the stationary layer of fluid attached to the GO flake or particle surface. The zeta potential typically depends from the nature of the material surface, and characteristics of the fluid that is in contact with the material surface (e.g., pH, ion concentration, ionic force, . . . ). The zeta potential may be determined out using an electrokinetic analyzer. Zeta potential may be determined using the Smoluchowski model.

Throughout the specification, unless otherwise defined, “average diameter” refers to an average of the longest diameter of each particle in the group.

As used herein, the term “fluidic communication” means that a fluid can pass through a first component and travel to and through a second component or more components regardless of whether they are in physical communication or the order of arrangement.

The term “microscale” and the related prefix “micro-” as used herein is intended to refer to items that have at least one dimension that is one or more micrometers and less than one millimeter.

The term “nanoscale” and the related prefix “nano-” as used herein (for example in “nanoparticle”) is intended to refer to measurements that are less than one micrometer.

The term “nanoparticle” includes, for example, “nanospheres,” “nanorods,” “nanocups,” “nanowires,” “nanoclusters,” “nanofibers,” “nanolayers,” “nanotubes,” “nanocrystals,” “nanobeads,” “nanobelts,” and “nanodisks.” Nanoparticles useable in the context of the present invention may be solid particles of nanoscale size.

The term “weight percent,” “wt. %,” “wt-%,” “percent by weight,” “% by weight,” and variations thereof, as used herein, refer to the concentration of a substance as the weight of that substance divided by the total weight of the composition and multiplied by 100.

As used herein, “about” refers to any inherent measurement error or a rounding of digits for a value (e.g., a measured value, calculated value such as a ratio), and thus the term “about” may be used with any value and/or range. As used herein, the term “about” can refer to a variation of ±5% of the value specified. For example, “about 50” percent can in some embodiments carry a variation from 45 to 55 percent. For integer ranges, the term “about” can include one or two integers greater than and/or less than a recited integer. Unless indicated otherwise herein, the term “about” is intended to include values, e.g., weight %, temperatures, proximate to the recited range that are equivalent in terms of the functionality of the relevant individual ingredient, the composition, or the embodiment.

As used herein, the term “and/or” means any one of the items, any combination of the items, or all of the items with which this term is associated.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible subranges and combinations of subranges thereof, as well as the individual values making up the range, particularly integer values. A recited range (e.g., weight percents, temperature, . . . ) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to,” “at least,” “greater than,” “less than,” “more than,” “or more,” and the like, include the number recited and such terms refer to ranges that can be subsequently broken down into subranges as discussed above. In the same manner, all ratios recited herein also include all subratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

The methods, systems, apparatuses, and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments or examples. The invention extends to any novel one, or any novel combination, of the features disclosed in this specification (including any accompanying claims, abstract and drawings), or to any novel one, or any novel combination, of the steps of any method or process so disclosed.

### Description of the Invention

Although the present disclosure will be described in terms of specific embodiments, it will be readily apparent to those skilled in this art that various modifications, rearrangements and substitutions may be made without departing from the spirit of the present disclosure. The scope of the present disclosure is defined by the claims appended hereto.

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

Illustrative embodiments are described below. In the interest of clarity, not all features of an actual implementation are described in this specification. It will of course be appreciated that in the development of any such actual embodiment, implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The GO-based composite membranes, systems and process in accordance with the present application overcome one or more of the above-discussed problems commonly associated with conventional GO-based membrane technology and processes. Specifically, the GO-based composite membranes of the present application exhibit increased water stability and resistance to water-swelling. This and other unique features of the GO-based composite membranes are discussed below and illustrated in the accompanying drawings.

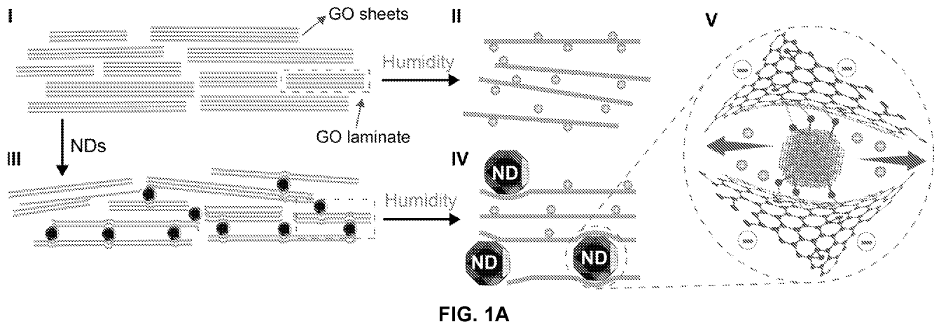

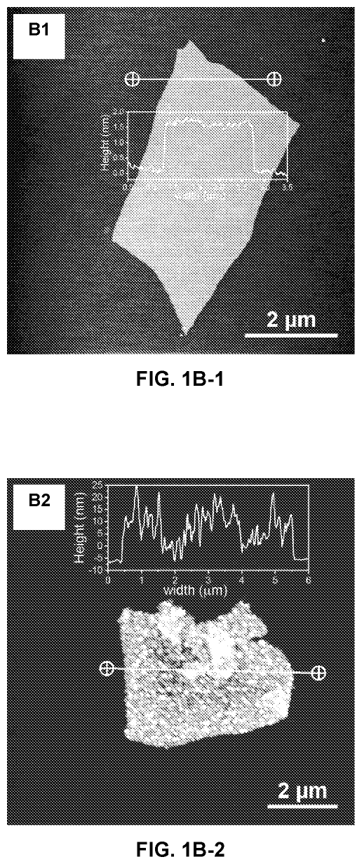

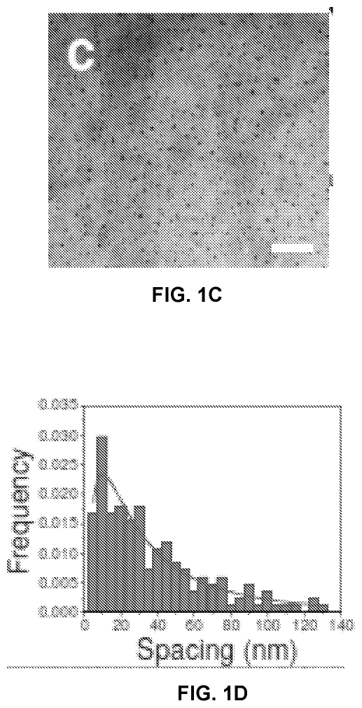

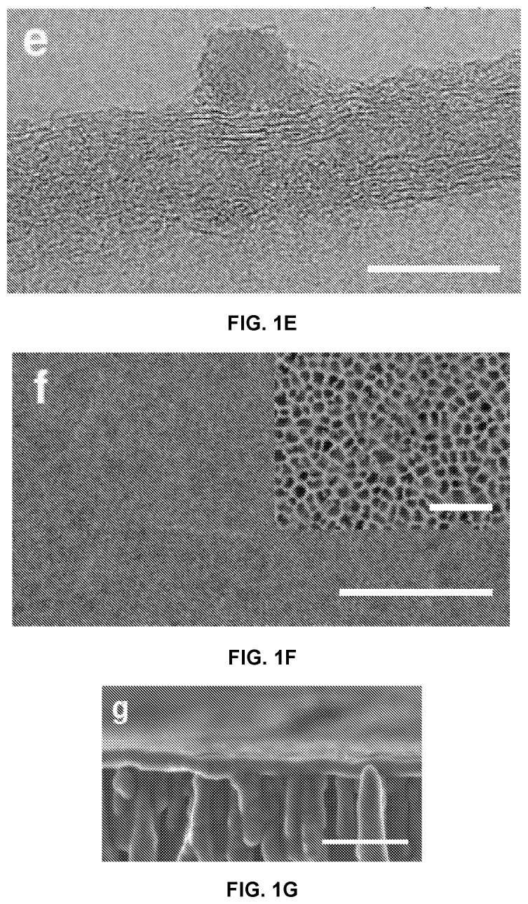

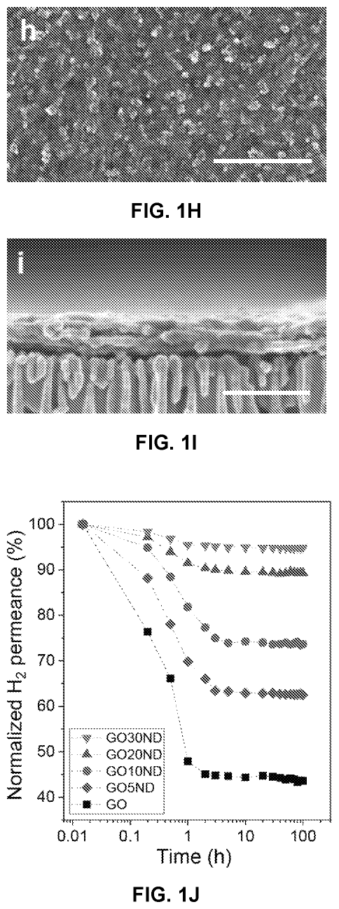

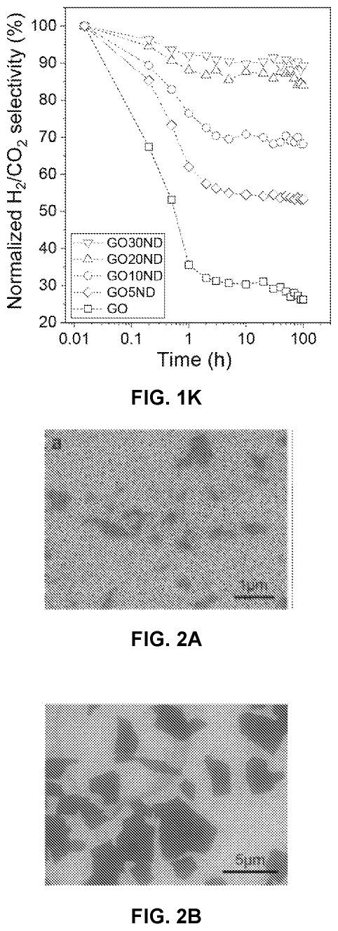

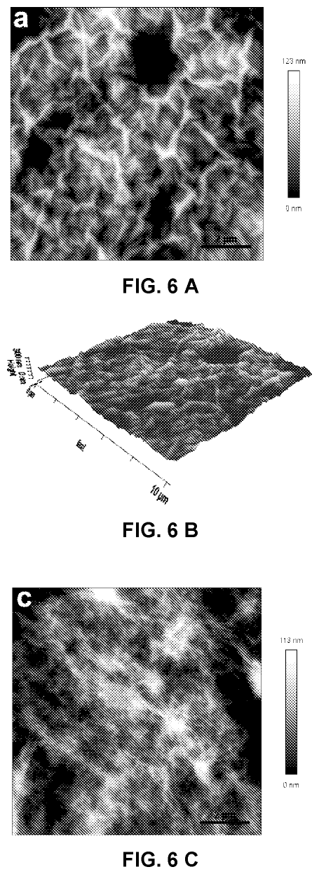

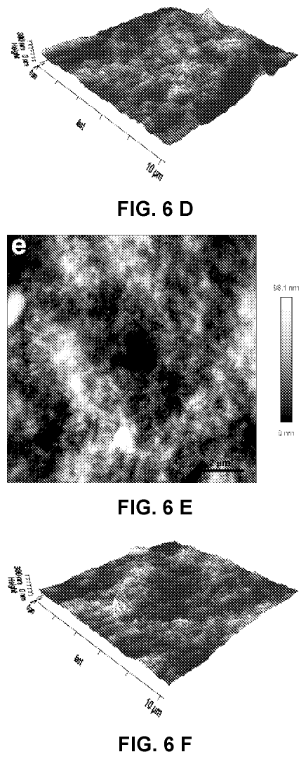

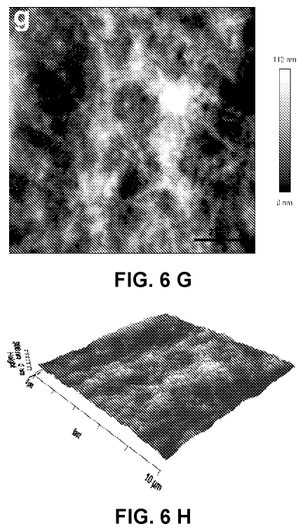

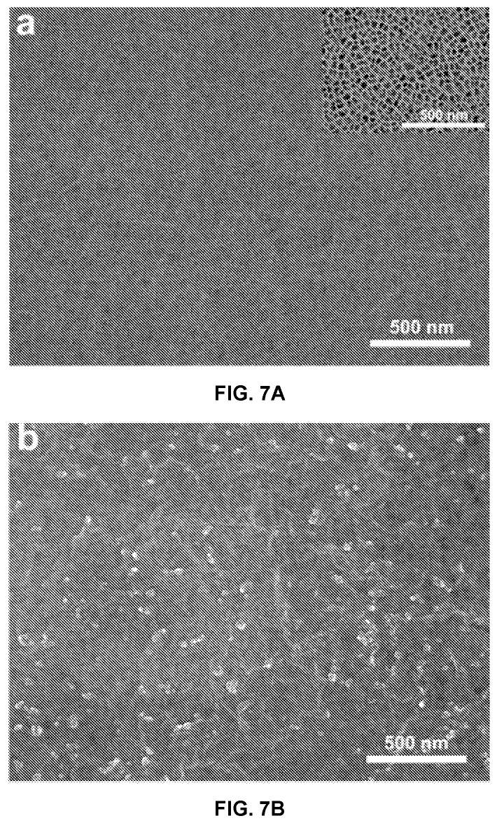

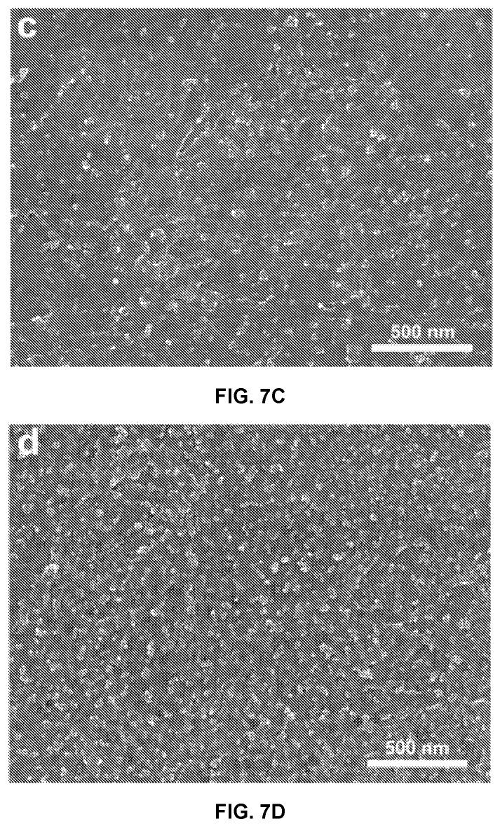

The GO-based composite membranes, systems and process will be understood, both as to its structure and operation, from the accompanying drawings, taken in conjunction with the accompanying description. Several embodiments of the GO-based composite membranes, systems and process are presented herein within FIGS. 1-24. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

As noted above, there is an unmet need for GO-based membranes with improved stability to humidity and resistance to water-swelling; and for a method of imparting water stability and improved resistance to water-swelling to GO-based membranes.

The present invention meets this need by providing a porous composite membrane comprising:
graphene oxide sheets; and
nanoparticles bound to a surface of the graphene oxide sheets solely by non-covalent interactions.

The non-covalent interactions comprise electrostatic and/or Van der Waals interactions. As used herein, the term “Van der Waals interactions” refers generally to any non-covalent interactions between materials. Van der Waals forces include dipole-dipole, dipole-induced dipole forces, and London dispersion forces. Hydrogen bonding being a dipole-dipole force, it is encompassed by Van der Waals forces.

The composite membrane may include a plurality of stacked graphene oxide sheets, and the nanoparticles may be intercalated between the stacks of graphene oxide sheets. Concerning the characterization of GO sheets, a series of characterization experiments may be performed to understand the unique shape, functionality, and other physicochemical properties of GO sheets. These experiments may include calculations related to zeta-potential analyzer for charge, Raman spectroscopy for G/D ratio, Fourier transform infrared spectroscopy (FTIR) and X-ray photoelectron spectroscopy (XPS) for functional groups, X-ray diffraction (XRD) for crystalline structure, and atomic force microscopy (AFM), SEM, and transmission electron microscopy (TEM) for size and shape. In particular, SEM and AFM techniques may be used to measure the size of GO flakes and thickness of the membranes.

The graphene oxide sheets in composite membranes according to the invention, may have an interlayer distance or d-spacing about 0.6-1.2 nm. For example, the GO sheet interlayer distance may range between 0.7-1.0 nm, for example 0.8-0.9 nm. The d-spacing can be determined by x-ray powder diffraction (XRD), using Bragg's law: d=λ/2 sin(θ) (1) where θ is half of diffraction angle and A is the wavelength of X-ray source. As will be understood by the reader, the d-spacing or the lattice spacing refers to the distance between the parallel planes of GO. In principle, XRD measures the average spacings between layers or rows of atoms. Accordingly, the GO interlayer distance or d-spacing reported herein refers to average values. Typically, the interlayer space between stacked GO sheets comprise hydrophilic domains, and hydrophobic domains. The GO sheet interspace hydrophilic domains are generally located where there are oxygen functionals groups at the edge and/or on the basal plane of GO sheets. By affinity with hydrophilic domains, water molecules may intercalate in the hydrophilic domains of stacked GO sheets. Without wishing to be bound by any particular theory, it is believed that the intercalation of nanoparticles between GO stacks creates or stabilizes areas in the GO sheet stacking where the hydrophobicity of the walls of the internal pores limits the penetration of water molecules, thereby imparting to the GO-based composite membrane less water affinity and greater resistance to water swelling. The graphene oxide sheets may have an average lateral size about 200 nm to 15 μm, for example 1 to 10 μm, for example about 1 to 6 μm. The graphene oxide sheet average lateral size may be determined using SEM. The nanoparticles may for example carry an overall positive charge, particularly on the outer surface of the nanoparticle, which is in electrostatic/Van der Waals interaction with the graphene oxide sheet surface. This positive charge is believed to favor electrostatic and/or Van der Waals interactions between the graphene oxide surface and the nanoparticles. Without wishing to be bound by any particular theory, it is believed that the presence of positively charged nanoparticles at the surface of the GO sheets contribute to neutralizing the negative charge of the stacked GO sheets (the GO sheets are not charged in dry state, but after exposure to water, GO sheets' surface becomes negatively charged mainly due to the deprotonation of hydroxyl groups) and stabilize the resulting membrane against humidity. For example, the nanoparticles may have a positive charge of not less than 30 mV Zeta potential at pH 7. The nanoparticle zeta potential may be determined using an electrokinetic analyzer. Suitable positively charged nanoparticles include, for example positively charged nanodiamonds, cationic POSS particles, cationic dyes, metal cations and double hydroxides. Nanoparticles useable in the context of the invention may be different from clay nanoparticles or MOF nanoparticles

Additional nanoparticles useable in the context of the invention may comprise metal nanocrystals such as Ag nanocrystals, porphyrins such as meso-(p-hydroxyphenyl) porphyrin nanocrystals and/or melamine nanoparticles. The adsorption of metal nanoparticles, porphyrins and melamine on GO sheet surface via non-covalent interaction has been described for example in refs {32-34}, respectively (2-dimensional assembly of a GO sheet with metal nanoparticles, porphyrins and melamine via non-covalent adsorption of the nanoparticles on the GO surface). However, the reports never considered the possibility of applying the non-covalent adsorption phenomenon to three-dimensional GO-based composite constructs, let alone that these may be used as membranes with sieving capacity. Composite GO-based membranes according to the present invention, using metal nanocrystals such as Ag nanocrystals, porphyrins such as meso-(p-hydroxyphenyl) porphyrin nanocrystals and/or melamine, as nanoparticles may be prepared according to the teachings of the present disclosure. For example, methods described in the Examples may be used, by substituting NDs with Ag nanocrystals, porphyrins nanoparticles and/or melamine nanoparticles.

The nanoparticles may have an average diameter of about 3 to 10 nm, for example 3 to 5 nm, for example about 3 nm or about 4 nm. If the nanoparticles have irregular shapes, some averaging may be made to report an average diameter. Known methods for measuring nanoparticle diameter, average diameter, and nanoparticle size distribution may be used. For example, nanoparticle average diameter may be measured using light scattering and Transmission electron microscopy methods (cf. Carvalho, Patricia M., et al. “Application of light scattering techniques to nanoparticle characterization and development.” Frontiers in chemistry 6 (2018): 237.), including some statistical analysis using a model such as the cumulant method (cf. {35}), for nanoparticles that do not all have the same size and/or geometry.

For example, an amount of about 5 to 40% wt of nanoparticles may be assembled on the graphene oxide sheet surface by electrostatic and/or Van der Waals interactions; the % wt being expressed based on the total weight graphene oxide sheets+nanoparticles. For example about 5 to 35% wt, or about 5 to 30% wt, or about 10 to 30% wt, or about 20 to 30% wt of nanoparticles may be used and be assembled on the graphene oxide sheet surface by electrostatic and/or Van der Waals interactions, to form the GO-based porous composite membrane according to the invention.

The nanoparticles may be carbonaceous nanoparticles (i.e., made of carbon atoms). This may be particularly advantageous owing to the compatibility of carbonaceous materials with graphene oxide. For example, the nanoparticles may include nanodiamonds. Nanodiamonds are carbon structures that can carry a positive charge, and are therefore particularly well suited for reducing to practice the present invention. In the present disclosure, nanodiamonds may be abbreviated “ND” to signify the presence of a positive charge that is present. When nanodiamonds are prepared so that they carry an overall negative charge, these will be designated “ND-”. Both ND⁺ and ND⁻ are commercially available, for example in the form of colloidal aqueous dispersions. Mention may be made, for example, of ND⁺ and ND⁻ colloidal aqueous dispersions, respectively, commercialized under the tradename of NanoAmando®. Without wishing to be bound by any particular theory, it is proposed that nanodiamonds (ND⁺), which feature a sp3/sp2 core-shell structure and positive surface charge, enhance the water-stability of GO membranes by reducing the electrostatic repulsive forces between hydrated GO sheets, thereby suppressing the random restacking and aggregation of GO sheets in the presence of humidity and strengthening the overall membrane structure.

Generally, a nanodiamond, as used herein, may be formed by an explosive reaction of graphite, and may be formed in fine nanoparticles having a size from about 3 to 10 nm, for example about 3 to 5 nm, for example about 3 nm or about 4 nm.

Porous GO-based composite membranes according to the invention may have a thickness ranging for example from 20-200 nm, or 25-150 nm, or 30-120 nm.

Porous GO-based composite membranes according to the invention present advantageous properties notably in terms of water stability, resistance to water-swelling, mechanical strength and separation performance.

Porous GO-based composite membrane according to the invention typically exhibit a H₂ permeance >1300 GPU for example, or ≥1800 GPU, or ≥2400 GPU, or ≥3500 GPU, as measured at 25±3° C. under dry conditions with a membrane thickness ranging from 30-120 nm. As used herein, by “dry conditions” it is understood a relative humidity in the range of <20% RH and atmospheric pressure.

Porous GO-based composite membrane according to the invention may exhibit an ideal gas selectivity α_{H2/CO2}>200 for example as measured with a continuous feed of equimolar H₂/CO₂ mixture at 25±3° C. under dry conditions with a membrane thickness ranging from 30-120 nm.

Porous GO-based composite membrane according to the invention may exhibit a H₂ permeance >750 GPU for example, or >1300 GPU, or ≥1800 GPU, or ≥2000 GPU, or ≥2400 GPU, or ≥3300 GPU, as measured at 25±3° C. under continuous feed of equimolar H₂/CO₂ mixture under humid conditions of 85% relative humidity with a membrane thickness ranging from 30-120 nm.

Porous GO-based composite membrane according to the invention may exhibit a H₂ permeance a ≥2× for example, or ≥3×, or ≥4×, or ≥5×, or ≥6×, or even a ≥7×, as compared to a pure graphene oxide membrane (0% wt nanoparticles) of equal thickness, as measured at 25±3° C. under continuous feed of equimolar H₂/CO₂ mixture under humid conditions of 85% relative humidity with a membrane thickness ranging from 30-120 nm.

Porous GO-based composite membrane according to the invention may exhibit a H₂ permeance, as measured at 25±3° C. under continuous feed of equimolar H₂/CO₂ mixture under humid conditions of 85% relative humidity, ≥60% for example, or ≥65%, or ≥70%, or ≥75%, or ≥80%, or ≥85%, or ≥90%, or ≥95%, as compared to the membrane H₂ permeance measured under dry conditions with the same temperature, membrane thickness and equimolar H₂/CO₂ mixture conditions with a membrane thickness ranging from 30-120 nm.

Porous GO-based composite membrane according to the invention may exhibit a H₂/CO₂ selectivity (α_{H2/CO2}), as measured at 25±3° C. under continuous feed of equimolar H₂/CO₂ mixture under humid conditions of 85% relative humidity, ≥50% for example, or ≥60%, or ≥70%, or a 80%, or ≥90%, as compared to the membrane H₂/CO₂ selectivity measured under dry conditions with the same temperature, membrane thickness and equimolar H₂/CO₂ mixture conditions with a membrane thickness ranging from 30-120 nm.

Porous GO-based composite membrane according to the invention may exhibit a hardness ≥610 MPa for example, or ≥630 MPa, or ≥650 MPa, or ≥670 MPa, or ≥690 MPa, or ≥700 MPa; or ≥710 MPa, as measured using the nanoindentation method at 25±3° C. with a Berkovich three-sided pyramid diamond tip (radius of 100 nm) at the load of 0.05 mN, the errors of measurements being reported based on the standard error of 20 indents.

Porous GO-based composite membrane according to the invention may exhibit a Young's modulus ≥15 GPa for example, or ≥16 GPa, or ≥17 GPa, or ≥18 GPa, or ≥19 GPa, or ≥20 GPa; or ≥21 GPa, as measured using the nanoindentation method at 25±3° C. with a Berkovich three-sided pyramid diamond tip (radius of 100 nm) at the load of 0.05 mN, the errors of measurements being reported based on the standard error of 20 indents.

As discussed before, porous composite membranes according to the invention may find use in any applications where porous GO-based membranes find use. One area of special interest is gas separation, particularly H₂ separation from gaseous mixtures. Accordingly, in any variant described herein, the porous GO-based composite membrane according to the present invention may be a GO-based composite hydrogen membrane, in particular a water-resistant GO-based composite hydrogen membrane.

Composite Membrane Preparation

In another aspect, the present invention provides a method of manufacturing a porous composite membrane according to the present invention, comprising the steps of:
(i) providing a dispersion of graphene oxide sheets, for example single-layered graphene oxide sheets, in an aqueous solvent;
(ii) providing a dispersion of nanoparticles in an aqueous solvent;
(iii) mixing the graphene oxide dispersion and the nanoparticle dispersion to form a dispersion of graphene oxide-nanoparticle composite; and
(iv) filtering the dispersion obtained in step (iii) through a porous support substrate to form a substrate-supported graphene oxide-nanoparticle composite membrane.

The preparation of graphene oxide-nanoparticle composite membranes supported on a porous membrane may also be achieved using spray coating, casting, dip coating techniques, road coating, inject printing, or any other thin film coating techniques.

The aqueous solvents in steps (i) and (ii) may be the same or different aqueous solvents. The aqueous solvent in steps (i) and (ii) may independently comprise water or alcohol/water mixtures, for example water. The alcohol may comprise methanol, ethanol, isopropanol, 1-butanol, tert-butanol, ethylene glycol, and the like, or a mixture of two or more of these. The aqueous solvents in steps (i) and (ii) may be one and the same aqueous solvent, and may be selected from water or alcohol/water mixtures, for example water. For example, the aqueous solvent in steps (i) and (ii) is water at pH=6-7.

Step (i) may comprise any method known in the art for dispersing graphene oxide. For example, step (i) may comprise sonicating a dispersion of graphene oxide in an aqueous solvent, the aqueous solvent being as defined in any variant herein.

Likewise, step (ii) may comprise any method known in the art for dispersing nanoparticles, including carbonaceous nanoparticles such as nanodiamonds. This may include, for example, ultrasound sonicating bath, ultrasound probe sonication, ultrasonic disruptor, high speed homogenizer, or high pressure homogenizer.

The method of manufacturing a porous composite membrane according to the present invention may further comprise a step of drying the substrate-supported graphene oxide-nanoparticle composite membrane obtained in step (iv). For example this may be carried out under vacuum at a temperature of about 50-70° C., to remove the excess aqueous solvent.

The dispersion of step (iii) may comprise an amount of for example about 5 to 40% wt of nanoparticles, or about 5 to 35% wt, or about 5 to 30% wt, or about 10 to 30% wt, or about 20 to 30% wt nanoparticles; the % wt being expressed based on the total weight graphene oxide sheets+nanoparticles.

Gas Separation System and Process

As discussed before, porous composite membranes according to the invention may find use in any applications where GO-based membranes find use. One area of special interest is gas separation, particularly H₂ separation from gaseous mixtures. Accordingly, in any variant described herein, the GO-based composite membrane according to the present invention may be a GO-based composite hydrogen membrane, in particular a water-resistant GO-based composite hydrogen membrane.

As such, in another aspect, the present invention provides a gas separation system comprising a porous composite membrane according to the present invention in fluidic communication with a gas stream containing a mixture of at least two separable gases including H₂, wherein the porous composite membrane comprises:
graphene oxide sheets; and
nanoparticles bound to a surface of the graphene oxide sheets solely by electrostatic and/or Van der Waals interactions.

In the gas separation system according to the invention, the porous composite membrane may be disposed on a porous support substrate. The porous support substrate may be any suitable support substrate. The porous support substrate may be a woven material or it may be a porous membrane.

For example, if present, the porous support substrate material may an inorganic material. Thus, the porous material (e.g. porous support substrate) may comprise a ceramic. For example, the porous support substrate material may be alumina, zeolite, or silica.

It may be that, if present, the porous support substrate material may be a polymeric material. Thus, the porous support substrate material may be a porous polymer support, e.g. a flexible porous polymer support. The porous material (e.g. porous support substrate) may comprise a polymer. The polymer may comprise a synthetic polymer.

For example, the porous support substrate may comprise a ceramic or polymeric porous support, including porous ceramic materials such as an alumina- or silica-based porous ceramic, and hydrophilic polymeric materials such as polysulfones (PS), polyethersulfones (PES), fluoropolymers such as polyvinylidene fluoride (PVDF), or polyacrylonitrile.

If present, the porous support substrate may have a thickness of no more than a few tens of μm, and may be less than about 1 mm thick or even less than about 100 μm. For example, it may have a thickness of 50 μm or less, or of 10 μm or less. In some cases it may be less than about 1 μm thick though in exemplary embodiments it may be more than about 1 μm.

The porous support substrate should be porous enough not to interfere with solute transport/permeation but have small enough pores that graphene oxide sheets cannot enter the pores. For example, the pore size may be less than 1 μm, e.g. less than 500 nm or less than 200 nm. Typically the pore size will be greater than 1 nm, e.g. greater than 10 nm.

The gas separation system according to the invention may be equipped with a porous composite membrane as defined generally and in any variant herein. For example, the porous composite membrane may include a plurality of stacked graphene oxide sheets, and the nanoparticles may be intercalated between the stacks of graphene oxide sheets. The gas separation system according to the invention featuring stacked GO sheets may be such that a molecule, such as H₂ gas, can flow through the nanochannels between GO layers while unwanted solutes are rejected by size exclusion and/or charge effects.

The gas separation system according to the invention may comprise a porous composite membrane having a hardness ≥610 MPa for example, or ≥630 MPa, or ≥650 MPa, or ≥670 MPa, or ≥690 MPa, or ≥700 MPa; or ≥710 MPa, as measured using the nanoindentation method at 25±3° C. with a Berkovich three-sided pyramid diamond tip (radius of 100 nm) at the load of 0.05 mN.

The gas separation system according to the invention may comprise a porous composite membrane having a Young's modulus ≥15 GPa for example, or ≥16 GPa, or ≥17 GPa, or ≥18 GPa, or ≥19 GPa, or ≥20 GPa; or ≥21 GPa, as measured using the nanoindentation method at 25±3° C. with a Berkovich three-sided pyramid diamond tip (radius of 100 nm) at the load of 0.05 mN.

The gas separation system according to the invention may comprise a plurality of GO-based composite membranes according to the invention. These may be arranged in parallel (to increase the flux capacity of the process/device) or in series.

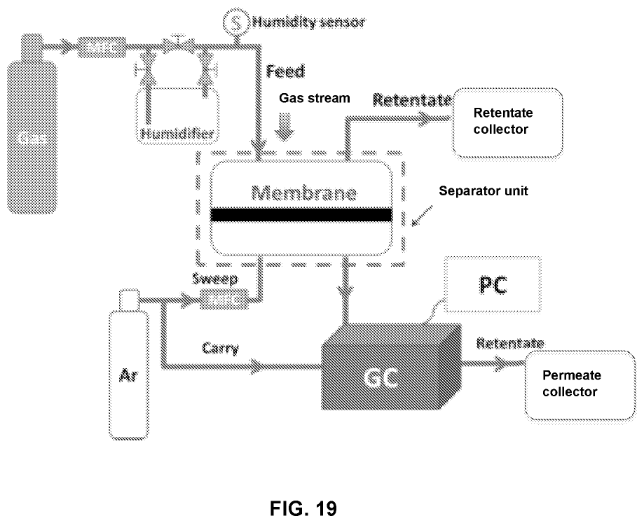

The gas separation system may be for example the system showed in FIG. 19. The gas separation system according to the invention may comprise:
a separator unit having an inlet, a retentate outlet, and a permeate outlet;
a gas stream in fluidic communication with the inlet of the separator unit, the gas stream comprising a mixture of at least two separable gases including at least H₂;
at least one porous composite membrane according to the present invention, as defined generally and in any variant herein, configured within the separator unit such that only permeates can flow from the inlet to the permeate outlet after first passing through the porous composite membrane and such that retentates flow from the inlet to the retentate outlet without passing through the porous composite membrane;
a retentate collector in fluidic communication with the retentate outlet of the separator unit; and
a permeate collector in fluidic communication with the permeate outlet of the separator unit.

As previously described, GO-based composite membranes according to the present invention may find use as H₂ separation membrane. As such, the gas separation system according to the present invention may be used with gaseous mixtures of at least two separable gases comprising at least H₂.

In another aspect, the invention provides a process for separating H₂ from a gas stream, comprising a step of permeating a mixture of at least two separable gases through a porous composite membrane according to the invention, wherein the gas mixture comprises at least H₂.

Porous composite membrane according to the present invention are suitable for separation of H₂ from any gas mixtures comprising hydrogen gas. For example, composite membrane according to the present invention may be used for the separation of H₂ gas from H₂/CO₂, H₂/Ammonia, H₂/O₂, H₂/N₂, H₂/CH₄ or H₂/CH₃CH₃ mixtures. For example, the gas stream may be natural gas. The use of porous composite membranes according to the invention in the separation of H₂ from H₂/O₂ gas mixtures is particularly interesting since O₂ and H₂ are formed by electrolysis of water.

### Water-Swelling Reduction

In yet another aspect, the invention relates to a process for reducing water-swelling in a graphene oxide-based hydrogen membrane, the process comprising associating nanoparticles in electrostatically and/or Van der Waals binding interaction with graphene oxide sheets constituting the graphene oxide-based hydrogen membrane.

It is to be understood that all the variants described above, notably for the various elements constituting the GO-based composite membrane according to the invention are applicable mutatis mutandis to each and every one of the sections above concerning “composite membrane preparation”, “gas separation process and system”, “process for reducing water-swelling”, and will be understood to apply to the compositions/methods/processes/systems/uses defined in the present disclosure. This includes all the variants described in the “DETAILED DESCRIPTION OF CERTAIN PREFERRED EMBODIMENTS OF THE INVENTION” section of this document, including any one and all variants, specifications and properties relating to the a) graphene oxide, b) nanoparticles, c) nanodiamonds, d) the description of separation properties (e.g., permeance, gas selectivity) of the membranes, and e) the description of mechanical properties (e.g., hardness, Young's modulus) of the membranes, which are all applicable mutatis mutandis to the compositions/methods/processes/systems/uses defined in the present disclosure, including each and every one of the sections above concerning “composite membrane preparation”, “gas separation process and system”, “process for reducing water-swelling”.

### Equivalents

The representative examples that follow are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples which follow and the references to the scientific and patent literature cited herein. It should further be appreciated that the contents of those cited references are incorporated herein by reference to help illustrate the state of the art.

The following examples contain important additional information, exemplification and guidance that can be adapted to the practice of this invention in its various embodiments and the equivalents thereof.

### Exemplification

The composite membranes of this invention and processes for their preparation can be understood further by the examples that illustrate some of the processes by which these composite materials are prepared or used. It will be appreciated, however, that these examples do not limit the invention. Variations of the invention, now known or further developed, are considered to fall within the scope of the present invention as described herein and as hereinafter claimed.

### Abbreviations

GO: graphene oxide

ND: nanodiamond

ND⁺: positively charged nanodiamond

ND⁻: negatively charged nanodiamond

POSS⁻: Octa(tetramethylammonium) functionalized Polyhedral Oligomeric Silsesquioxanes, which is negatively charged.

POSS⁺: Octa(tetramethylammonium) functionalized Polyhedral Oligomeric Silsesquioxanes, which is positively charged.

GOαND⁺ membrane: GO-nanodiamond composite membrane according to the invention, a representing the weight concentration of ND⁺ particles in the composite membrane.

GOαND⁻ membrane: GO-ND⁻ composite membrane, α representing the weight concentration of ND⁻ particles in the composite membrane.

GOαPOSS⁻ membrane: GO-POSS⁻ composite membrane, α representing the weight concentration of negatively charged Polyhedral Oligomeric Silsesquioxanes particles in the composite membrane.

GOαPOSS⁺ membrane: GO-POSS⁺ composite membrane according to the invention, α representing the weight concentration of positively charged Polyhedral Oligomeric Silsesquioxanes particles in the composite membrane.

Materials

Graphite powder was obtained from Qingdao Nanshu Graphite Co., Ltd.

The aqueous colloidal solutions of positively and negatively charged nanodiamond (ND) particles, respectively, each with an average size of 3.8±0.7 nm in water (2.5 wt. %), NanoAmando®, were supplied by Nano Carbon Research Institute Co., Ltd (Japan).

The octa(tetramethylammonium)- and octa(ammonium)-functionalized water-soluble Polyhedral Oligomeric Silsesquioxane (POSS) particles with the chemical formulas of Ca₂H₉₆N₈O₂₀Si₈ (negatively charged) and C₂₄H₇₂Cl₈N₈O₂Si₈ (positively charged), respectively, were supplied by Hybrid Plastics Inc. (Hattiesburg, US).

10 mL of GO, ND, and POSS dispersions were freeze-dried to measure the concentration of the original dispersions precisely using an ultramicrobalance.

Characterization

The as-prepared membranes were characterized by FTIR spectroscopy (Shimadzu IRTracer-100 spectrometer, Japan) in the range of 4000-600 cm⁻¹. The X-ray diffraction (XRD) patterns were collected at BL02B2 of SPring-8 (A=0.999190 A), Japan Synchrotron Radiation Research Institute (JASRI). The crystalline structure of membranes was determined by wide-angle XRD analysis (Rigaku, Smartlab). The samples were scanned at the rate of 10° per min over a 29 range of 4-40° using a Cu Kα anode under a voltage of 40 kV and a current of 200 mA. X-ray photoelectron spectroscopy (XPS) measurements were obtained using an X-ray Photoelectron Spectrometer (ESCA-3400, Shimadzu). The binding energy of the impurity carbon (1s) peak (the C1s peak) was adjusted to 284.6 eV to correct the chemical shifts of each element. Raman microspectroscopy was performed using a 532 nm excitation laser with 20-25 mV (Horiba XploRa, Japan).

The morphology of membranes was observed by Field Emission Scanning Electron Microscopy (FESEM instrument, Hitachi S-4800). Transmission electron microscope (TEM) images were collected on a JEOL JEM 1400 plus (120 kV) and JEM-2200FS setup (JEOL) (200 kV). The samples were freeze-fractured in liquid nitrogen and briefly sputter-coated with osmium to prevent electron charging. The morphologies of the GO-based membranes were measured by atomic force microscopy (AFM, NanoWizard III, JPK Instruments, Japan) in tapping mode.

SEM and AFM measurements were also conducted to measure the lateral size and thickness of the GO nanosheets.

Particle size distributions and zeta potential values of membrane precursors were measured using a Malvern Zetasizer Nano instrument (Malvern Panalytical Ltd.).

H₂, CO₂ and N₂ adsorption isotherms of the membranes were recorded up to 1 bar at 298 K or 77K using BELSORP-Max (BEL-Japan Inc.). Samples were degassed offline at 80° C. for 24 hr under dynamic vacuum (10-5 bar) before analysis.

The Young's modulus (E) and indentation hardness (H) were measured at room temperature using a nanoindentation tester (ENT 2100, Elionix) equipped with a Berkovich three-sided pyramid diamond tip (radius of 100 nm) at the load of 0.05 mN. For PM0.3 rejections, the as-prepared or water-immersed (and air-dried) membranes were studied using a handheld particle counter KC-51 (RION. Co., Ltd.). The rejection values were reported based on the average values of three separate measurements of different membrane samples.

Gas Permeation Tests

The gas permeation measurements were conducted by a homemade membrane permeation/separation setup (FIG. 19). The membrane gas permeation measurements were conducted using a Wicke-Kallenbach cell (FIG. 19) at atmospheric pressure. In order to avoid the damage of the selective layer, the edge of the membrane disks was masked with aluminum tape precoated with a rubber pad before starting the measurements. The volumetric flow rate of feed gases was kept at 50 mL min⁻¹ and 100 mL min⁻¹ for single- and mixed-gas measurements, respectively, by digital mass flow controllers (Horiba, Japan). Argon was used as the sweep gas at a constant volumetric flow rate of 50 mL min⁻¹ to eliminate concentration polarization in the permeate side. To avoid physical damage of the GO based membranes, we covered the membrane's surface with air-tight tape before gas permeation tests (hole diameter: −6 mm). The pressure gradient was negligible between the feed and permeate sides of the membranes.

For hydrated gas permeation tests, the equimolar H₂/CO₂ mixture was passed through a gas bubbler filled with saturated solutions of LiCl (12% RH), MgCl₂ (33% RH), NaCl (75% RH) and water (85% RH) and a humidity sensor prior to the permeation cell. For the simulated water splitting test, the 90 mL min⁻¹ of H₂:O₂ (2:1) was prior passed through a water bubbler (85% RH) to the permeation cell. Gas permeation behaviors of the membranes at different temperatures were studied at a temperature-controlled chamber. The membranes were kept at each temperature for more than 3 h. A calibrated gas chromatograph (Shimadzu GC-2014) was used to analyze the composition of the permeate gas.

The gas permeance (Pi, GPU) was calculated using the following equation:

$${P}_{i} = \frac{Ni}{A . Δ {p}_{i}} \qquad ( 1 )$$

where Ni is the permeate rate of component i, mol s-1; Dpi is the transmembrane pressure difference of component i, Pa, and A (m2) is the membrane area.

The ideal selectivity (αi/j) is defined as the permeance of gas “i” relative to that of gas “j” and is expressed by:

α_{i/j}=Pᵢ/Pⱼ (2)

For mixed gas, the separation factor αi/j was defined as the molar ratio of two-component in the permeate and feed side:

$${α}_{i / j} = \frac{{y}_{i} / {y}_{j}}{{x}_{i} / {x}_{j}} \qquad ( 3 )$$

where x and y are the volumetric fractions of the corresponding component in the feed and permeate side, respectively.

### Example 1—Preparation of GO-ND⁺ Composite Membranes

Synthesis of GO

Single-layered graphene oxide (GO) was prepared by a modified hummers' method. Briefly, 1 g of graphite powder (mesh size 50, Qingdao Nanshu Graphite Co., Ltd.) was added to a 9:1 (v/v) mixture of concentrated H₂SO₄/H₃PO (120:14 mL) in an ice bath and stirred for 20 min. Then, 6 g of KMnO₄ was gradually added to the reaction media, and the mixture was stirred at 50° C. for 4 h, 8 h, and 24 h for the large-size GO (LGO), (medium-size) GO, and small-size GO (SGO), respectively. The reaction was cooled to room temperature and poured slowly onto 150 mL of cold water (0-2° C.), then 2 mL of 30% H₂O₂ was added dropwise until the color of the solution turns to pale yellow. The product was filtered with 10% aqueous HCl (750 mL) and thoroughly washed with distilled water until the pH value reached 6-7.

10 mL of GO dispersions were freeze-dried to measure the concentration of the original dispersions precisely using an ultramicrobalance.

Membrane Preparation

The as-prepared Hummers product was sonicated at 40 W for 1 hr (Branson 1510E-MT) to exfoliate the GO sheets. Upon sonication, the resulting dispersions were subjected two times (each time 30 min) centrifugation at 5,000 r.p.m. to remove un-exfoliated and large flakes. The supernatant was further centrifuged at 10,000 r.p.m. for 40 min to remove small-size GO flakes and obtain GO dispersion. The un-exfoliated particles were eliminated from LGO dispersion by 3 min of bath sonication, followed by centrifugation at 3,000 r.p.m. for 20 min. Then, repeat centrifugation at 5,000 r.p.m. for 30 min to collect the sediment. For SGO, 4 h sonication and 10,000 r.p.m. for 1 h were conducted to collect the supernatant. To obtain a uniform membrane, a certain amount of GO dispersion was pre-diluted to 0.001 mg/mL and then vacuum filtrated (GCD-051X, ULVAC vacuum pump) at 10 Pa vacuum pressure through the anodic aluminum oxide (AAO) filters (pore size: 20 nm, diameter: 25 mm, Whatman) or polyethersulfone (PES, pore size: 30 nm, diameter: 25 mm, Sterlitech Co., Ltd.). The fresh positively charged ND⁺ dispersion was centrifuged at 10,000 r.p.m. for 1 h to remove any aggregates A calculated amount of ND⁺suspension (5 to 35 wt %) was added into the diluted GO dispersions under bar stirring for 10 min. Resulting GO-ND⁺ dispersions were then subjected to mild bath sonication for 10 min at 23 W just before depositing composite GOαND⁺ membranes by vacuum filtration. The total mass of GO and GOαND were kept the same for all samples (0.03 mg). The resulting membranes were vacuum-dried at 60° C. for 24 hr to remove the residual water before further characterizations. For PM0.3 rejections, the GO-based membranes (total mass: ˜0.01 mg) were vacuum filtrated on polyethersulfone substrate (100 kDa, diameter: 25 mm, Synder Co.).

### Comparative Example 2

For comparison, a specific amount of negatively charged POSS particles was firstly dispersed in water and sonicated for 5 hr. The GOαPOSS⁻ membranes were fabricated using the same method as the GO-based composite membranes of Example 1.

### Comparative Example 3

For comparison, Example 1 was repeated using negatively charged ND (ND⁻) dispersions.

### Example 4

For comparison, Comparative Example 2 was repeated using positively charged POSS particles.

Results

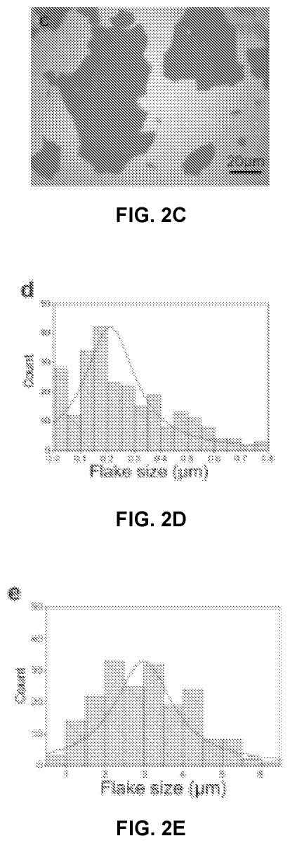

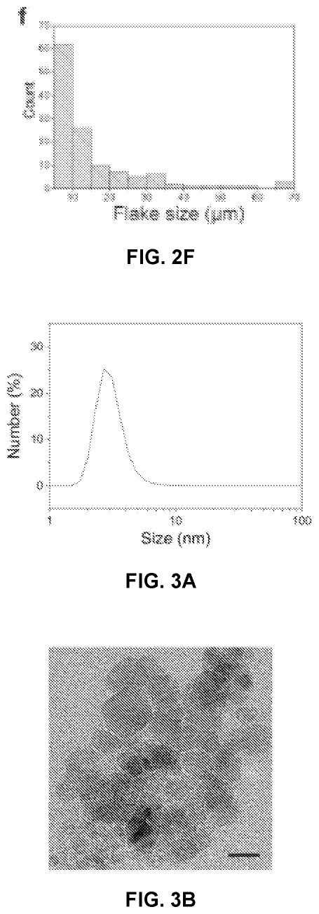

GO membranes were prepared, by a common vacuum filtration method of a dispersion of single-layer GO sheets (FIG. 1B-1, FIG. 2) onto both ceramic and polymeric supports. (Note: the lateral size of GO sheets plays an important role in manipulating the 2D channels for the selective transport of gas molecules. The average lateral size of the GO sheets was obtained by scanning electron microscopy (SEM) images. For preparing SEM samples, 1 μg/mL of GO dispersion was dropped on the surface of AAO and air dried for 24 h. The lateral size of GO sheets was calculated from the average size of more than 120 sheets as shown in FIG. 2).

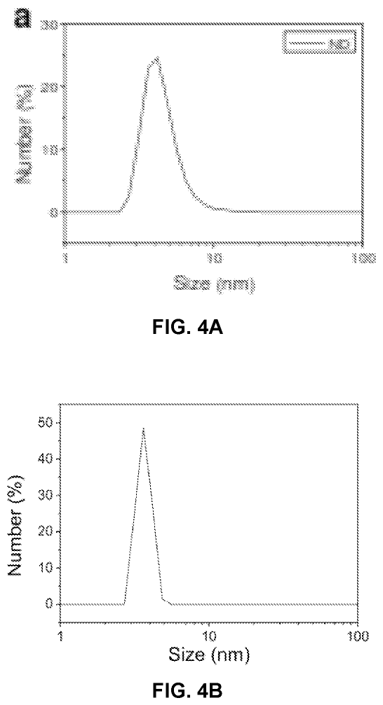

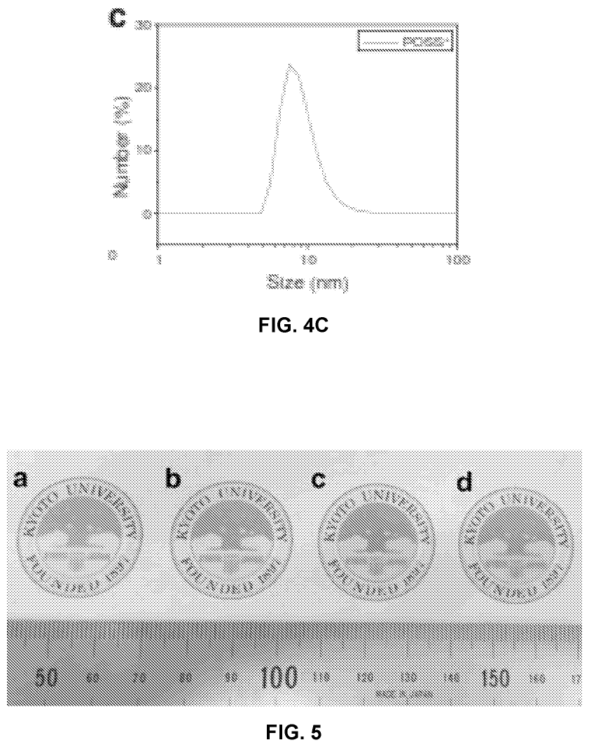

3 nm-sized ND⁺s were controllably introduced into the membrane by adding them to the GO dispersions before vacuum filtration (FIG. 3). Similarly sized anionic nanodiamond (ND⁻) and polyhedral oligomeric silsesquioxane (POSS) nanoparticles with positive (POSS⁺) and negative (POSS⁻) charges were also used as comparative fillers (FIG. 4). Even at high-loading ratios (i.e., ND⁺ loading of 30 wt. %), ND⁺s finely dispersed on isolated GO surfaces (FIGS. 1C, 20 and Note to FIG. 20), with an average particle-particle distance of around 10 nm (FIG. 1D). The prepared membranes were designated as GOαND⁺, where α (α=5, 10, 20, 30 and 35) represents the weight concentration of ND⁺ particles with reference to the total mass of the membrane. The scanning electron microscopy (SEM) and atomic force microscope (AFM) images (FIG. 1F, 1G and FIGS. 5-7) of the GO-only membrane revealed a smooth surface without visible defects. However, the surface roughness of the composite membrane increased by the addition of ND⁺ particles (FIGS. 1H, 6 and 7 and Table 1).

TABLE 1
Surface roughness parameters of GO-based membranes

| Membranes | GO | GO10ND⁺ | GO20ND⁺ | GO30ND⁺ |
|---|---|---|---|---|
| Ra (nm) | 27.13 ± 2.3 | 38.95 ± 3.1 | 52.71 ± 5.7 | 71.74 ± 6.4 |
| Rq (nm) | 38.70 ± 3.5 | 47.77 ± 3.9 | 65.30 ± 5.6 | 89.28 ± 7.5 |

H₂ Permeance

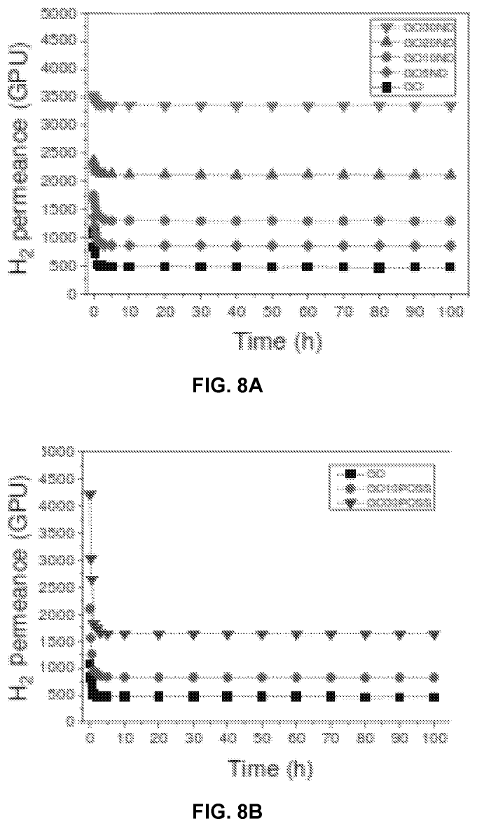

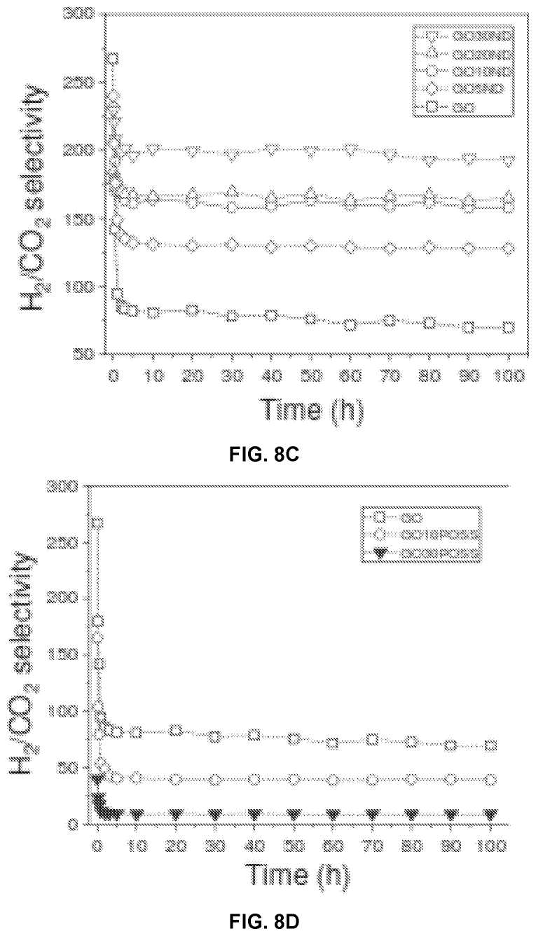

On ceramic supports, the produced native GO membranes were found to have performances comparable to, or slightly better than, those reported in the literature with initial H₂ permeance of around 1150 GPU and ideal gas selectivity of ˜282 against CO₂ (Tables 2 and 3). However, when exposed to a water-saturated equimolar mixed-gas feed, the GO membrane performances dramatically deteriorated over a 100-hr test at room temperature. Permeances and selectivity dropped by 55% and 70% respectively (FIGS. 1J-K, and FIG. 8). By contrast, GO30ND⁺ exhibited the H₂ permeances thrice the level of native GO membranes (to 3741 GPU), and with a relatively small reduction in ideal gas selectivity (to α_{H2/CO2}˜212) when tested with dry gas. However most significantly, there was only a ˜5% and ˜10% drop in permeance, and selectivity of GO30ND⁺ membranes, respectively, when also tested extensively with a wet mixed-gas feed.

TABLE 2
Single gas permeance of GO based membranes 25° C.

| | Permeance (GPU)^{a} | | | | | |
|---|---|---|---|---|---|---|
| | H₂ | CO₂ | O₂ | N₂ | CH [symbol] | C [symbol] H [symbol] |
| GO | 1156.3 ± 101.4 | 4.1 ± 0.6 | 11.6 ± 1.2 | 10.7 ± 1.2 | 15.2 ± 1.6 | 0.7 ± 0.1 |
| GO5ND [symbol] | 1472.1 ± 120.3 | 5.8 ± 1.0 | 16.1 ± 1.7 | 14.5 ± 1.6 | 21.6 ± 2.3 | 0.9 ± 0.2 |
| GO10ND⁺ | 1004.6 ± 152.3 | 7.7 ± 1.0 | 20.7 ± 2.1 | 19.8 ± 2.0 | 33.9 ± 3.1 | 1.3 ± 0.2 |
| GO20ND⁺ | 2498.6 ± 178.6 | 10.1 ± 1.2 | 31.2 ± 2.8 | 29.5 ± 2.8 | 55.1 ± 5.7 | 2.1 ± 0.2 |
| GO30ND⁺ | 3741.2 ± 214.7 | 17.6 ± 1.8 | 50.4 ± 5.1 | 47.1 ± 5.2 | 98.8 ± 10.5 | 3.7 ± 0.3 |
| GO35ND⁺ | 4406.3 ± 286.2 | 46.4 ± 4.1 | 143.6 ± 17.5 | 132.3 ± 16.2 | 278.5 ± 37.7 | 12.8 ± 1.9 |
| 5GO | 186 [symbol] ± 175.0 | 10.4 ± 1.1 | 36.2 ± 3.0 | 33.1 ± 2.9 | 47.2 ± 5.1 | 2.3 ± 0.1 |
| 5GO30ND⁺ | 4432.5 ± 466.5 | 42.3 ± 5.8 | 148.6 ± 15.2 | 13.6.1 ± 14.4 | 250.7 ± 26.5 | 12.3 ± 1.4 |
| LGO | 548.5 ± 43.9 | 1.4 ± 0.1 | 4.1 ± 0.5 | 3.9 ± 0.5 | 5.6 ± 0.7 | — |
| LGO30ND⁺ | 2153.2 ± 214.3 | 8.3 ± 1.0 | 25.6 ± 2.7 | 23.8 ± 2.5 | 46.2 ± 5.1 | 1.8 ± 0.2 |
| GO5POSS⁻ | 1716.5 ± 1471.5 | 7. [symbol] ± 1.1 | 20.7 ± 2.0 | 18.3 ± 2.0 | 33.2 ± 3.2 | 1.2 ± 0.2 |
| GO10POSS⁻ | 2216.8 ± 181.4 | 12.6 ± 1.3 | 40.7 ± 3.4 | 38.3 ± 3.3 | 59.2 ± 6.0 | 3.1 ± 0.3 |
| GO20POSS⁻ | 3137.4 ± 223.7 | 35.5 ± 3.3 | 86.3 ± 8.6 | 70.1 ± 8.2 | 152.7 ± 19.1 | 10.4 ± 1.3 |
| GO30POSS⁻ | 4459.2 ± 468.3 | 97.8 ± 9.1 | 210.3 ± 32.0 | 198.4 ± 30.7 | 312.5 ± 40.0 | 20.6 ± 4.3 |

^{a}The gas permeances are reported based on the average values of three separate measurements of different membrane samples. GPU is gas permeation unit; 1 GPU = 3.35 × 10⁻¹⁰ mol m⁻² s⁻¹ Pa⁻¹ [symbol]
indicates data missing or illegible when filed

TABLE 3
Ideal gas selectivity of GO-based membranes at 25° C.

| | Ideal Selectivity | | | |
|---|---|---|---|---|
| Membrane | H [symbol] /CO [symbol] | H [symbol] /N [symbol] | H [symbol] /CH [symbol] | H [symbol] /C [symbol] H [symbol] |
| GO | [symbol] | [symbol] | [symbol] | [symbol] |
| GO5ND⁺ | [symbol] | [symbol] | [symbol] | [symbol] |
| GO10ND⁺ | [symbol] | [symbol] | [symbol] | [symbol] |
| GO20ND⁺ | [symbol] | [symbol] | [symbol] | [symbol] |
| GO30ND⁺ | [symbol] | [symbol] | [symbol] | [symbol] |
| GO35ND⁺ | [symbol] | [symbol] | [symbol] | [symbol] |
| SGO | [symbol] | [symbol] | [symbol] | [symbol] |
| SGO30ND⁺ | [symbol] | [symbol] | [symbol] | [symbol] |
| LGO | [symbol] | [symbol] | [symbol] | — |
| LGO30ND⁺ | [symbol] | [symbol] | [symbol] | [symbol] |
| GO5POSS⁺ | [symbol] | [symbol] | [symbol] | [symbol] |
| GO10POSS⁺ | [symbol] | [symbol] | [symbol] | [symbol] |
| GO20POSS⁺ | [symbol] | [symbol] | [symbol] | [symbol] |
| GO30POSS⁺ | [symbol] | [symbol] | [symbol] | [symbol] |

a. The ideal gas selectivity data are reported based on the average values of three separate measurements of different membrane samples. [symbol]
indicates data missing or illegible when filed

The results show that ND⁺s could stabilize the performance of the GO-based membranes.

Composite Membrane Morphology—GO/ND⁺ Interaction

A detailed examination of the interaction of the ND⁺s with the GO sheets was performed.

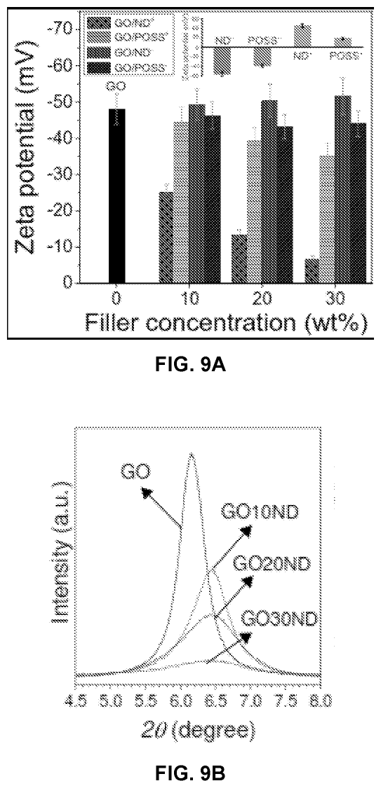

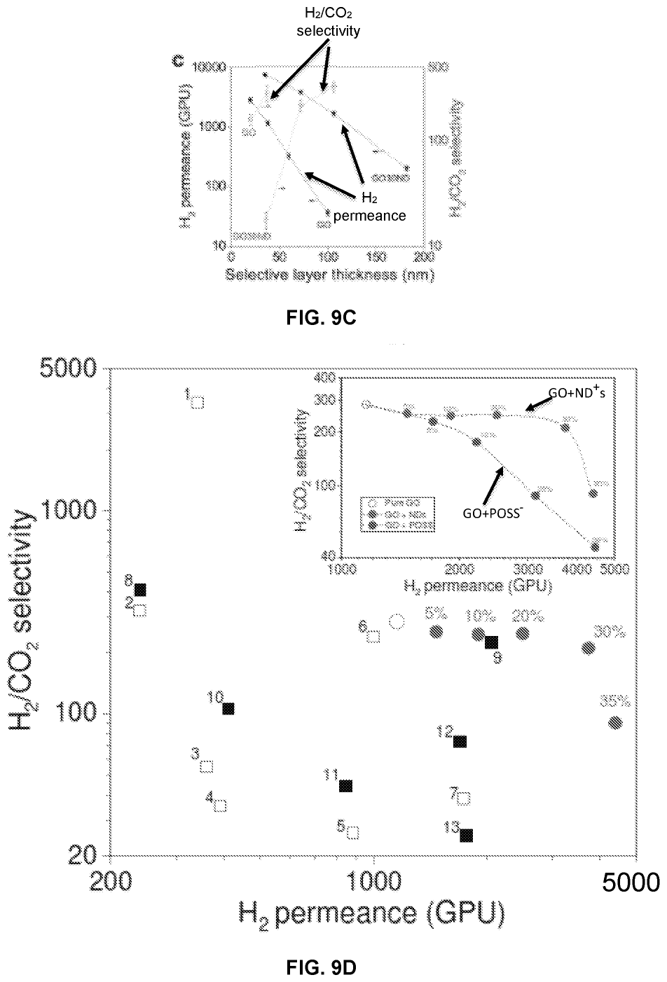

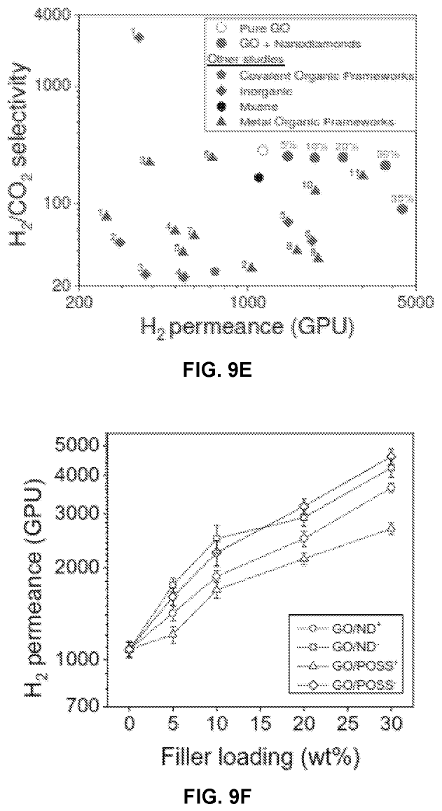

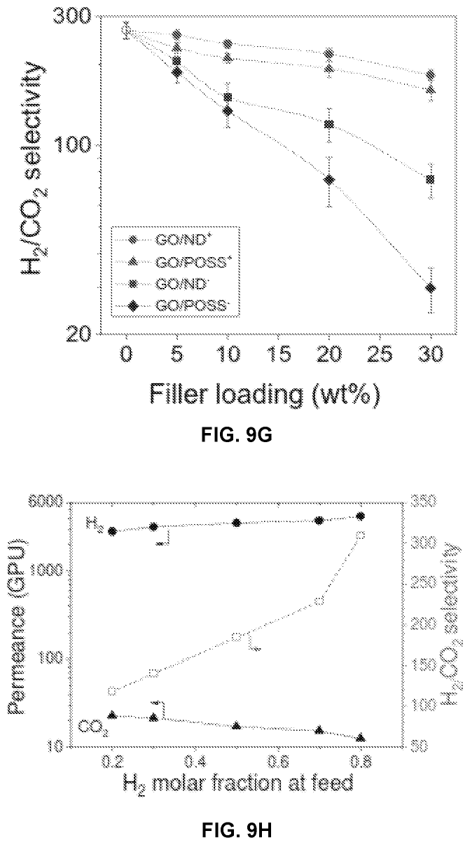

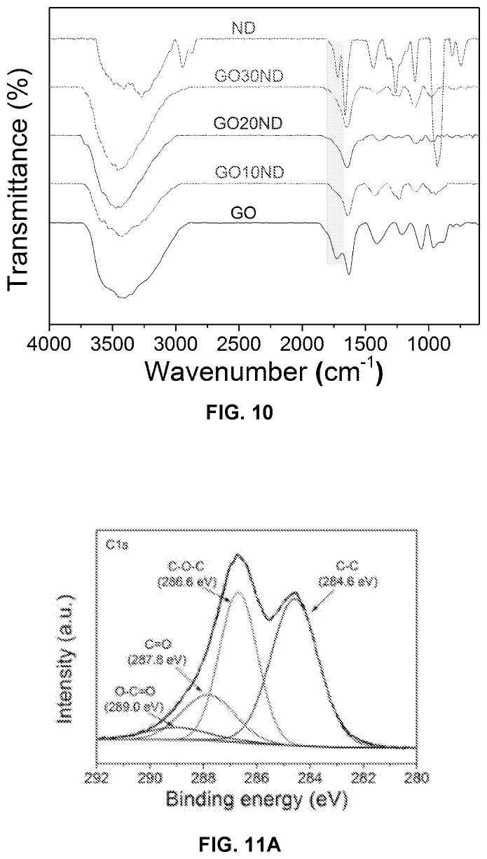

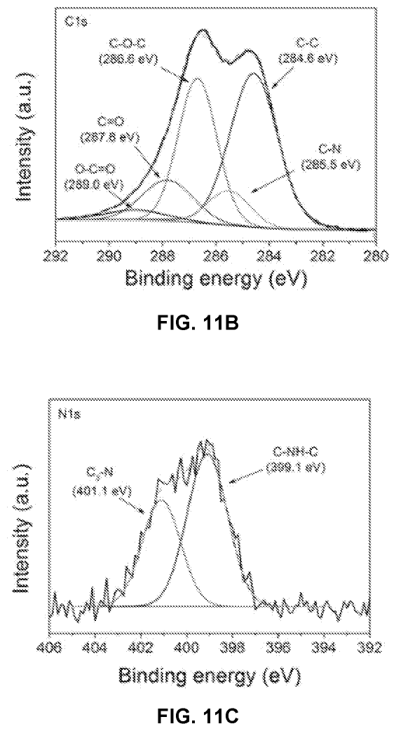

The ND⁺ particles were positively charged (+45 mV), while the GO sheets carry a net negative charge (˜48 mV) at pH=7 (FIG. 9A), thereby allowing the proper assembling of ND⁺s into the GO structure via strong electrostatic interactions. Even though the ND⁺s altered the stacking character of the GO laminates, the composite membrane remained intact due to the electrostatic interactions and hydrogen bondings between the GO sheets and ND⁺ particles. Hydrogen bonding in the GOαND⁺ membranes was verified by a shift of prominent bonding peak in FTIR spectra (FIG. 10) s. C1s and N1s X-ray photoelectron spectroscopy (XPS) spectra confirmed the presence of ND⁺ in the GO mixtures (see FIG. 11 and Table 4).

TABLE 4
Elemental analysis of GO and GO30ND⁺ membranes

| Membranes | C % | N % | O % | O/C |
|---|---|---|---|---|
| GO | 64.68 | — | 35.32 | 0.55 |
| ND⁺ | 94.07 | 1.61 | 4.32 | 0.046 |
| GO30ND⁺ | 68.72 | 1.47 | 29.81 | 0.43 |

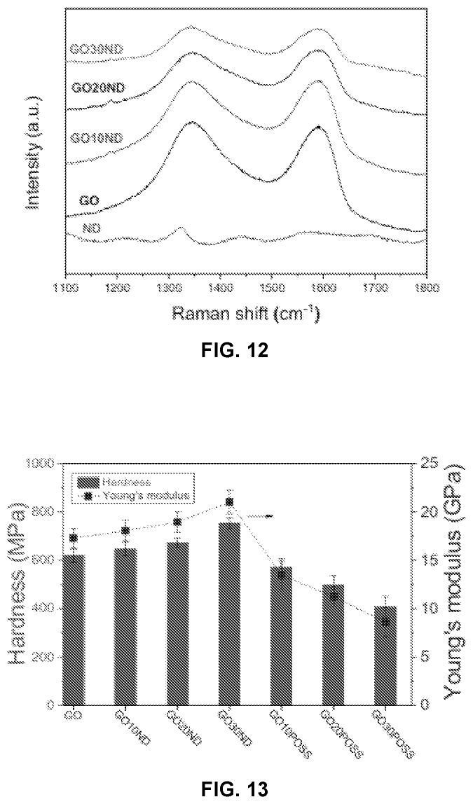

X-ray diffraction of the GO and GOαND⁺ samples were particularly revealing. The sharp peak of the GO membrane at 20=6.15° suggests highly ordered stacking of GO laminates with the d-spacing of 0.93 nm (FIG. 9B). The intensity of the peak decreased and broadened by the introduction of ND⁺s, which confirms the disruption of GO stacked ordering. Furthermore, the peak shifted slightly by the addition of ND⁺s, and the equivalent d-spacing reached 0.89 nm in GO30ND⁺ membranes. The combination of ND⁺ or POSS⁺ nanoparticles with GO caused a charge compensation effect (FIG. 9A), which would contribute to the reduction of d-spacing in resulting GO laminates by weakening of the interlayer electrostatic repulsion (FIG. 9B). Moreover, the bending of flexible GO sheets by the incorporation of ND⁺ particle (FIG. 9E), causing a narrower interlayer spacing. In addition to the XRD peak intensity, the peak width can also be correlated to the size of GO laminates. The insertion of positively charged ND particles (ND⁺) between the GO laminates diminished the negative charge effect (FIG. 9A), weakened the interlayer electrostatic repulsion and narrowed the channel size. In addition to the XRD peak intensity, the peak width can also be correlated to the size of GO laminates. The average crystallite width and the number of GO layers in each laminate are inversely proportional to the width of the diffraction peak according to the Debye-Scherer equation (Note re: Table 5). A significant decrease in the GO crystallite size was observed by increasing the ND⁺s content (Table 5), which reflects the disruption of stacked GO laminates, and the formation of more grain boundaries inside the composite membranes. Raman spectroscopy indicated the disruption of GO laminates through the addition of ND⁺ particles (FIG. 12). Although the functional groups on the surface of GO are responsible for its well-compact structure, the existence of spherical ND⁺ particles in the solution inhibits the individual GO sheets from restacking (FIG. 12).

TABLE 5
synchrotron radiation diffractions of GO and
GOαND⁺ membranes.

| | | d-spacing | Crystallite | Stacking |
|---|---|---|---|---|
| Membranes | 2θ (°) | (Å) | width (Å) | layer |
| GO | 6.154 | 9.299 | 126.4 | 14.6 |
| GO10ND⁺ | 6.432 | 8.896 | 82.8 | 10.3 |
| GO20ND⁺ | 6.436 | 8.891 | 58.6 | 7.6 |
| GO30ND⁺ | 6.439 | 8.886 | 44.3 | 6.0 |

Note re:
Table 5: The X-ray diffraction of the GO/NDs composites provides quantitative insights regarding useful information about the average interlayer spacing, and dimensions (layer number and average width) of well-stacked the number of GO layers per domain and crystallite size in the composites. The d-spacing (1), crystallite width (2) and stacking layers (3) were calculated using the following equations.

The X-ray diffraction peak of the GO based membranes, corresponding to the interlayer spacing of GO sheets stacks and can be calculated by using Bragg's equation:

Bragg's law: d=λ/2 sin(θ) (1)

where θ is half of diffraction angle and λ is the wavelength of X-ray source.

The peak width of GO based membranes reflect the average size of the GO domains (crystallites) in each sample, which are separated by the grain boundaries and large lateral defects. The Debye-Scherer equation can be used to determine the average width crystallite width (D) of the GO domains

D=0.89λ/β cos(θ) (2)

where D is the crystallite width, β is the full peak width of the diffraction peak at half maximum height (FWHM) expressed in radians.

The average number of GO layers per domain (N) explains provides insights regarding the re-stacking ability degree of the GO nanosheets after upon the incorporation of ND particles. The combination of Bragg and Debye-Scherer equations (1 and 2) is used for calculating the average number of layers in GO stacks (stacking layers):

N=D/d+1 (3)

where D and d, are the crystallite width and inter-layer spacing, respectively.

Composite Membrane Mechanical Properties

It was found that both Young's modulus and hardness of the GOαND⁺ membranes also improved up to ˜25% compared to the pristine GO membrane (FIG. 13). Young's modulus and hardness of the GOαND⁺ membranes became 2 15 GPa and a 610 MPa, respectively. The improved mechanical properties can be explained by the favorable interaction between GO and ND⁺ which is desired for practical applications and long-term operation of the membranes.

Gas Separation

Primarily, the separation of H₂ and CO₂ is discussed in detail in this section. However, other industrially important hydrogen gas pairs were tested (H₂/O₂, H₂/N₂, H₂/CH₄, and H₂/C₂H₆) performed equally well as summarized in Tables 2 and 3 (cf. supra).

The gas diffusion in the GO membrane takes place between the edges and interlayer galleries of adjacent sheets. Therefore, not only the membrane thickness but also the lateral dimension of the GO sheets (FIG. 2) are important to generating high-flux membranes. Increasing membranes thickness boosts the molecular sieving effect, increasing selectivity. When the overall ratio of GO to ND⁺ is unaltered, the effective permeances of all gases decrease in thicker membranes (FIG. 9C). H₂ permeance of the membrane with the smallest platelet size (ca. 200 nm, FIG. 2) is 60% and 240% higher than the values of the membranes with average sheet sizes of 3 and 10 μm, respectively. Although higher tortuosity of the larger sheets reduced the gas diffusivity, it promoted the sieving ability, more than doubling the selectivity of the membranes with the largest GO sheets. We also observed the same trend for ND⁺-incorporated (GOαND⁺) membranes (Tables 2 and 3).

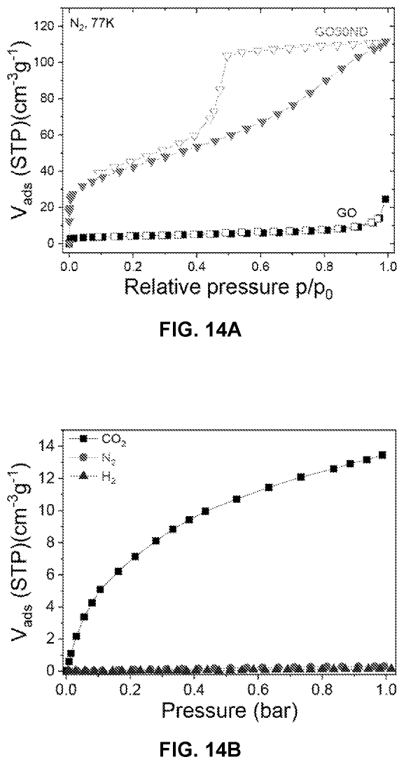

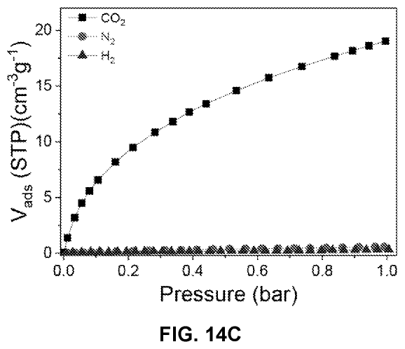

The cross-section view of the GO membrane in FIG. 1G displays a highly packed morphology with a uniform thickness of about 38±6 nm. The addition of ND⁺ particles (30 wt %) to the GO matrix increased the membrane thickness up to 75±8 nm (FIG. 11). The GO, GOαND⁺ thicknesses reported herein are dependent on the initial concentration of GO and ND⁺ in the vacuum filtration solution. Without wishing to be bound by any particular theory, it is believed that with increases in thickness, there are more free spaces between packed GO laminates. With this in mind, we report membrane permeances for GOαND⁺ system thicknesses where selectivity can be reliably determined. The incremental addition of ND⁺ particles into the GO structure improved its gas permeation in a controlled and significant manner while the separation factors were almost at the same level as GO membranes especially at low filler concentrations, i.e., up to 30 wt % (FIG. 9D-inset). An H₂ permeance of ˜3741 GPU (α_{H2/CO2}=212) was observed in the GO30ND⁺ membrane; an exceptional ˜300% enhancement in the permeance compared to the pure GO membrane (FIG. 9D and Tables 2 and 3). Without wishing to be bound by any particular theory, it is believed that the decrease in the number of GO layers and the shrinkage of the crystallite width of the GO laminates are responsible for the permeance enhancement (Table 5). N₂ adsorption test indicated a 500% enhancement in the pore volume from 0.036 cm³/g for the pure GO membrane to 0.17 cm³/g by the addition of 30 wt % ND⁺ particles, which facilitates the gas diffusivity in the composite membrane (FIG. 14A). The increase in the thickness of the unfilled GO membrane from 38±6 nm to 75±8 nm (FIGS. 1G and 1I) for GO30ND⁺ is proof of the opening of the structure by adding fillers. Generally, compared across a wide spectrum of inorganic materials, including silica, and MOFs {23}, COFs {14}, and MXenes {21}, the GO30ND⁺ membrane show both exceptional H₂ permeance (>3700 GPU) and H₂/CO₂ selectivity (>200) (FIG. 9E and Table 6). In previous studies, the intercalation of different particles in the GO laminates caused higher permeance at the expense of a considerable decline in selectivity. We, however, achieved a negligible loss of selectivity with exceptionally high permeance.

TABLE 6
reported gas separation data of membranes known in the art,
for H₂ separation.

| | | H₂/CO₂ | H₂ | | |
|---|---|---|---|---|---|
| | Temp./ | Ratio at | Permeance | α (H₂/ | |
| Membrane | ° C. | feed | (GPU) | CO₂) | Ref. |
| GO | 20 | 50/50 | 341 | 3400 | 11 |
| GO | 25 | Single gas | 239 | 323 | 30 |
| GO | 25 | Single gas | 354 | 58 | 31 |
| GO | 25 | Single gas | 392 | 35.3 | 32 |
| GO/TiO₂ | 25 | Single gas | 885 | 26 | 23 |
| GO | 25 | 50/50 | 1002 | 240 | 33 |
| GO | 25 | Single gas | 1739 | 38.5 | 34 |
| GO/ZIF-8 | 25 | 50/50 | 240 | 406 | 35 |
| TU-GO | | Single gas | 2063 | 225 | 36 |
| GO/MOF | 25 | Single gas | 412 | 106 | 24 |
| GO/MoS₂ | 25 | Single gas | 846 | 44.2 | 37 |
| GO/MOF | 25 | 50/50 | 1700 | 73.2 | 38 |
| rGO/ZIF-8 | 25 | Single gas | 1768 | 25.3 | 25 |
| 2D COF | 25 | 50/50 | 732 | 26.7 | 39 |
| SiC | 400 | Single gas | 354 | 2600 | 40 |
| Zeolite | 400 | Slagle gas | 295 | 47 | 41 |
| ZSM- | 450 | Single gas | 377 | 25.3 | 42 |
| 5/silicalite | | | | | |
| ZIF-9 | 25 | Single gas | 545 | 23.8 | 43 |
| Silica | 200 | 50/50 | 1474 | 71 | 44 |
| Silica | 200 | Single gas | 1857 | 46 | 45 |
| MXene | 25 | 50/50 | 1113 | 167 | 46 |
| CuBTC/MIL- | 25 | Single gas | 260 | 77.6 | 47 |
| 100 | | | | | |
| NH₂-UiO-66 | 20 | 50/50 | 1039 | 28.2 | 48 |
| 2D MOF | 25 | 50/50 | 392 | 225 | 49 |
| | | | 715 | 245 | |
| Co₂(bim)₄ | 30 | Single gas | 501 | 58.7 | 50 |
| JUC-150 | 25 | 50/50 | 539 | 38.7 | 51 |
| ZnBTC | 250 | | 602 | 53 | 52 |
| CNT@IL/ | 25 | Single gas | 1605 | 40 | 53 |
| ZIF-9 | | | | | |
| JUC-160 | 25 | Single gas | 1969 | 34.2 | 54 |
| Zn₂(Bim)₃ | 20 | 50/50 | 1919 | 128.4 | 55 |
| 2D ZIF₈ | 25 | 50/50 | 3020 | 172 | 56 |

The evaluation of gas separation properties of the membranes was investigated under the mixed-gas feeds. Using equimolar H₂/CO₂ feed mixture, H₂ permeance and H₂/CO₂ selectivity of the GO30ND⁺ membrane decreased 6% and 13%, respectively (Table 7, FIG. 9H).

TABLE 7
Single gas and equimolar mixed gas permeations of GO30ND⁺ membrane.

| | | Single gas | | | Mixed gas | | | |
|---|---|---|---|---|---|---|---|---|
| | [symbol] | Permeance (GPU) | | Ideal | Permeance (GPU) | | Seperation | H₂ |
| Gas i/j | constant | i | j | selectivity | i | j | factor | purity (%) |
| H₂/CO₂ | 4.7 | 3741.2 | 17.6 | 211.6 | 3532.5 | 17.7 | 184.7 | 99.47 |
| H₂/CO₂ | N/A | N/A | N/A | N/A | 3319.1 | 17.9 | 171.5 | 99.42 |
| (Hydrated) | | | | | | | | |
| H [symbol] /N [symbol] | 3.7 | 3741.2 | 47.1 | 79.4 | 3594.48 | 52.63 | 63.19 | 98.44 |
| H [symbol] /CH [symbol] | 2.8 | 3741.2 | 98.8 | 38.2 | 3566.74 | 112.79 | 29.32 | 96.70 |
| H [symbol] /C [symbol] H [symbol] | 3.9 | 3741.2 | 3.7 | 1012.8 | 3672.73 | 4.14 | 808.83 | 99.88 |

[symbol]

indicates data missing or illegible when filed

The reduction in the permeance and selectivity of the membranes under the mixed-gas condition is, in general, due to the partial hindrance of H₂ molecules transport by highly adsorbed CO₂ molecules (FIGS. 14B-C). It can be expected to worsen in high CO₂ concentration feeds. Thus a 25% and 45% reduction in H₂ permeance and selectivity is observed for ≥20:80 H₂/CO₂ feed mixture (FIG. 9H). Nevertheless, considering that the absolute permeances and selectivity are in the top range for membrane materials, the loss in performance under these more realistic conditions is acceptable. It is important to consider the temperature window that a gas separation membrane can afford for different application scenarios. Therefore, we tested GO30ND⁺ membranes at elevated temperatures. As a general trend, we observed higher gas permeance for both CO₂ and H₂ molecules as the temperature increases. However, because of the significant reduction of CO₂ adsorption at higher temperatures, which favors CO₂ flux in this system, H₂/CO₂ selectivity showed a declining trend (FIG. 21). Nevertheless, these membranes showed functionality up to 80° C., apparently because of the minimal change in the interlayer spacing of the membranes up to this temperature (FIG. 22).

Stability Against Water, Humidity, and Aerosols

Compelling evidence for the stabilizing property of ND⁺s against humidity can be ascertained from their immersion in aqueous conditions the immersion of GO30ND⁺ membranes in water (FIG. 15A). Here, thicker GO membranes (˜200 nm) prepared over a larger area by vacuum filtration on polyethersulfone supports are seen to disintegrate upon immersion to liquid water, whereas GO30ND⁺ membranes are stable over the same period. A more severe stability test was also performed of the ND⁺ stabilization effect is demonstrated by exposing the membranes cyclically to wet and dry feeds of H₂/CO₂ mixture (85% relative humidity) (FIG. 15B). Native GO membranes could not survive a single full cycle exposure, becoming fully permeable to both gases. Interestingly, the membrane worsens after being exposed to a second dry-gas feed, suggesting that significant and irreversible structural reorganization takes place during both wetting and drying of the hygroscopic material. The changes in the d-spacing values (FIG. 15C), delamination of the GO selective layer from the AAO (FIG. 15E), and the emergence of blisters at the surface of GO membranes (FIG. 15F) under humidity conditions confirmed the structural disruption. On the other hand, GOαND⁺ membranes exhibited a larger degree of reversibility in membrane properties when exposed to wet and dry gases. The stability of the composite membrane was also evident by the conservation of interlayer spacing and overall membrane structure under humidity (FIG. 15D and FIG. 23). Whilst the data presented in FIGS. 1J-K showed membrane permeances in 85% relative humidity and with stability enhanced by ND⁺ content, the variation of membrane permeance and selectivity is directly relatable to the level of humidity (FIGS. 15G-H and FIG. 24). This quasi-reversible variation of membrane performance under cycling or constant humidity conditions, suggests that the ND⁺s are noncovalently stabilizing the GO laminates within the membrane.

Impact of Intercalated Positively Charged ND⁺s

In the context of the present invention, in exemplary embodiments, GO-based composite membranes were produced at neutral or near-neutral solution conditions (pH ˜6-7): destabilization under humid conditions was minimized presumably by limiting the GO laminate's mobility that arises due to the electrostatic repulsion between the negatively charged GO sheets. An effect of the intercalation of positively charged ND⁺s between the GO laminates is that the negative charge of GO sheets has been partially neutralized, thereby mitigating the strong repulsion of the GO layers.

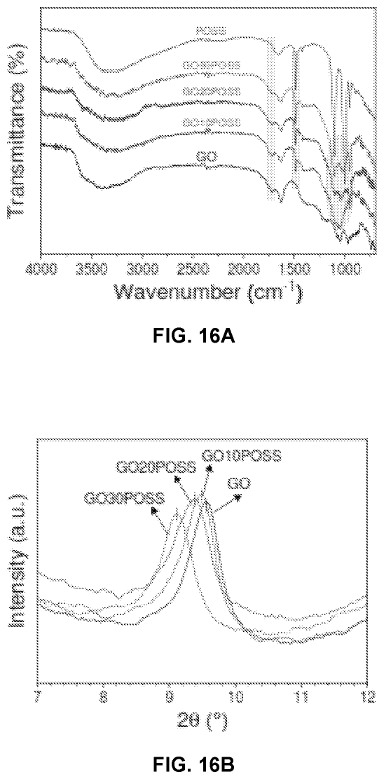

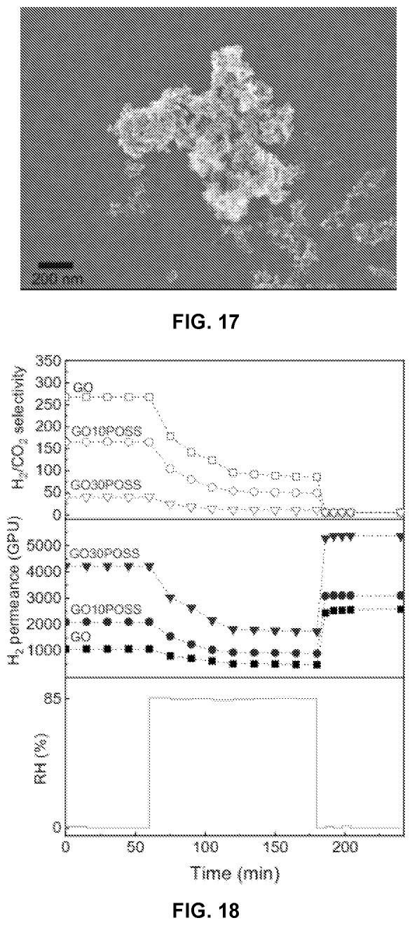

To test the generalizability of the charge compensation effect, we exploited another type of positively charged particle, POSS⁺. As negative controls, we also prepared ND⁻ and POSS⁻ incorporated GO membranes at different loadings (FIGS. 2F and 2G). The addition of a similarly sized negatively-charged POSS⁻ (˜30 mV) was explored in Comparative Example 2. An identical array of characterization was performed on the GOαPOSS⁻ materials (FIG. 9A). The results showed that the interaction between the GO sheets and POSS⁻ nanofillers was weak as confirmed by the FTIR and WXRD data (FIG. 16). As a result, inferior mechanical properties of GOαPOSS⁻ composite membranes were found (FIG. 13), which were related to the severe agglomeration of the particles within the GO framework (SEM image in FIG. 17). Unlike the GOαND⁺ composite membranes, the gas permselectivity of GOαPOSS⁻ membranes was much lower than the pure GO membrane due to the severe agglomeration and formation of non-selective interfacial defects (Tables 2 and 3). Additionally, the GOαPOSS⁻ structures revealed unstable performance under humid gas feed or in continuous cyclic operations under dehydrated-hydrated equimolar H₂/CO₂ mixture (FIGS. 8B and 18).

The results obtained with GOαPOSS⁻ membranes are consistent with previous reports of GO-based membranes with GO sheets intercalated with foreign particles (for example, the intercalation of MOF additives to GO systems). Invariably, the reports are of increased permeance through the intercalation, but with a loss in selectivity (FIG. 9D and Table 6). We observe the same with the addition of negatively charged POSS⁻ fillers in Comparative Example 2.

This comes in striking contrast with what was observed with the GOαND⁺ systems described in Example 1, which reinforces the notion that the enhanced performance of the GOαND⁺ systems according to the invention can be correlated to the extent of interaction of the positively charged ND⁺ additive and its chemical similarity with its surroundings.

Weak interactions between the negative-charged particles and GO flakes were noted by the Fourier-transform infrared spectroscopy (FTIR), wide-angle X-ray diffraction (WXRD) and severe agglomeration (FIGS. 16 and 17). The inferior mechanical properties of GOαPOSS⁻ (FIG. 13) also suggest the lack of strong interactions between the POSS⁻ and GO layers. Unlike the GOαND⁺ membranes, the H₂/CO₂ selectivity of the GOαPOSS⁻ and GOαND⁻ significantly drop to 30 and 74 under equimolar H₂/CO₂ mixture feed, respectively (FIG. 2G). The destabilization under humid conditions is minimized by limiting the GO laminate's mobility owing to the electrostatic repulsion between the negatively charged GO sheets. The intercalation of ND⁺ and POSS⁺ particles into GO laminates has partially neutralized the negative charge of GO sheets and mitigated the strong repulsion of the layers (FIG. 2A). As the lack of electrostatic stabilization is lacking in GOαPOSS⁻ and GOαND⁻ systems, those membranes exhibited an erratic performance under humid gas feed (FIG. 15J) or in continuous cyclic operations of dehydrated-hydrated equimolar H₂/CO₂ mixtures (FIG. 18). It has been reported that charged clays and other ions can stabilize thicker (18-20 μm) GO sheets against dissolution in water. Within the present disclosure, where membranes are produced at near-neutral solution conditions (pH ˜6-7), the intercalation of positively charged ND⁺s between the GO laminates has partially neutralized the negative charge of GO sheets and mitigated the strong repulsion of the layers.

We have further expanded the application space of GOαND⁺ membranes by the upgrading of a water-splitting product (H₂O₂ mixture with ˜66% H₂). As shown in FIG. 15I and Table 8, the H₂O₂ selectivity of GO30ND⁺ membranes reached ˜42 and remained unchanged over a series of wet/dry cycles measurements. Despite higher H₂O₂ selectivity ˜84, the GO membrane was not selective under a single full cycle. Therefore, the addition of ND⁺s is an effective strategy to overcome the instability of GO membranes for the purification of H₂ produced by water splitting. Since the water might be present in the molecular or aerosol form, the resistance of the membranes against macroscale reorganization was corroborated by testing aerosol transportation through membranes that had been significantly aged by liquid exposure (FIG. 15K). GOαND⁺-based materials that could be demonstrated to not only prevent the passage of PM0.3 aerosol particles at the efficiency of 99%, but which can also be stable in the presence of water, whilst PM0.3 rejection efficiency dropped to 40% for GO membranes pretreated in water as an accelerated aging test.

TABLE 8
The H₂/O₂ separation performance of GOαND⁺
membranes under dry (RH. 0%) and humid (RH. 85%)
conditions using mixed-gas feed (H₂/O₂: 66/33, vol. %).

| | | | | | H₂ |
|---|---|---|---|---|---|
| | RH. | H₂ | O₂ | H₂/O₂ | purity |
| Membranes | (%) | permeance | permeance | selectivity | (%) |
| GO | 0 | 1018.7 | 11.7 | 84.7 | 98.86 |
| | 85 | 402.6 | 7.1 | 58.0 | 98.26 |
| GO30ND⁺ | 0 | 3218.6 | 71.8 | 41.8 | 97.82 |
| | 85 | 2808.4 | 62.4 | 42.3 | 97.83 |

### CONCLUSIONS

In summary, the Examples illustrate the use of positively charged nanodiamonds (ND⁺s) or POSS⁺ nanoparticles that neutralize the negative charge of the stacked GO sheets and stabilize the resulting membrane against humidity. Whereas a native GO membrane lost all of its sieving capability under aggressive humidity cycling tests, GOαND⁺ composite membranes were found to retain up to ˜90% of their stability under the same conditions. Specifically, the Examples show the stabilization of GO-based membranes towards adverse humid conditions, whilst maintaining the membranes' overall high performance towards H₂/CO₂ separation. This was achieved via the intercalation of positively charged nanodiamonds (ND⁺s) which feature a sp3/sp2 core-shell structure and positive surface charge or POSS⁺ nanoparticles. The positively charged ND⁺s or POSS⁺ nanoparticles reduce the electrostatic repulsive forces between hydrated GO sheets, where their robust and GO compatible structures are intercalated between the GO laminates, strengthening the membrane structure. As a result, the random restacking and aggregation of GO sheets in the presence of humidity is suppressed (FIG. 1A).

The ND⁺ addition was shown to extend the permeance of the native membrane by a factor of 3 (to ˜3700 GPU) without drastically affecting the overall hydrogen selectivity of the membrane (e.g. αH₂/CO₂˜210). Positive results were also shown in the case of the addition of POSS⁺ nanoparticles.

As a control, similarly-sized but negatively charged nanodiamonds (ND-s) or polyhedral oligomeric silsesquioxanes (POSS⁻) additives were found to bring no enhancement to the swelling resistance of GO-based membranes.

In the present Examples, the benefit of the addition of positively charged nanoparticles, such as carbonaceous nanoparticles, has therefore been demonstrated, notably through ND⁺s or POSS⁺ nanoparticles that serve to stabilize negatively charged GO membranes against humidity and enhanced destabilization of the membrane's separation performance, whilst enhancing its intrinsic separation performance tremendously.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, and it is intended that this information can be employed herein, if needed, to exclude (for example, to disclaim) specific embodiments that are in the prior art. For example, when a composition is claimed, it should be understood that compositions known in the prior art, including certain compositions disclosed in the references disclosed herein, are not intended to be included in the claims.

### LIST OF REFERENCES

1. Li, H. et al. Ultrathin, molecular-sieving graphene oxide membranes for selective hydrogen separation. Science 342, 95-98 (2013).
2. Ma, S. et al. Surfactant-modified graphene oxide membranes with tunable structure for gas separation. Carbon (2019).
3. Meng, X. et al. Improving hydrogen permeation and interface property of ceramic supported graphene oxide membrane via embedding of silicalite-1 zeolite into Al₂O₃hollow fiber. Separation and Purification Technology, 115712 (2019).
4. Ibrahim, A. & Lin, Y. Gas permeation and separation properties of large-sheet stacked graphene oxide membranes. Journal of membrane science 550, 238-245 (2018).
5. Zeynali, R., Ghasemzadeh, K., lulianelli, A. & Basile, A. Experimental evaluation of graphene oxide/TiO2-alumina nanocomposite membranes performance for hydrogen separation. International Journal of Hydrogen Energy (2019).
6. Chi, C. et al. Facile preparation of graphene oxide membranes for gas separation. Chemistry of Materials 28, 2921-2927 (2016).
7. Zeynali, R., Ghasemzadeh, K., Sarand, A. B., Kheiri, F. & Basile, A. Performance evaluation of graphene oxide (GO) nanocomposite membrane for hydrogen separation: Effect of dip coating sol concentration. Separation and Purification Technology 200, 169-176 (2018).
8. Wang, X. et al. Improving the hydrogen selectivity 1 of graphene oxide membranes by reducing non-selective pores with intergrown ZIF-8 crystals. Chemical Communications 52, 8087-8090 (2016).
9. Yang, J. et al. Self-Assembly of Thiourea-Crosslinked Graphene Oxide Framework Membranes toward Separation of Small Molecules. Advanced Materials 30, 1705775 (2018).
10. 41 Li, Y., Liu, H., Wang, H., Qiu, J. & Zhang, X. GO-guided direct growth of highly oriented metal-organic framework nanosheet membranes for H2/CO2 separation. Chemical science 9, 4132-4141 (2018).
11. Ostwal, M., Shinde, D. B., Wang, X., Gadwal, I. & Lai, Z. Graphene oxide-molybdenum disulfide hybrid membranes for hydrogen separation. Journal of membrane science 550, 145-154 (2018).
12. Kang, Z. et al. In situ generation of intercalated membranes for efficient gas separation. Communications Chemistry 1, 3 (2018).
13. Li, W. et al. Hydrothermally Reduced Graphene Oxide Interfaces for Synthesizing High-Performance Metal-Organic Framework Hollow Fiber Membranes. Advanced Materials Interfaces 5, 1800032 (2018).
14. Fan, H. et al. Covalent Organic Framework-Covalent Organic Framework Bilayer Membranes for Highly Selective Gas Separation. Journal of the American Chemical Society 140, 10094-10098 (2018).
15. Nagano, T., Sato, K. & Kawahara, K. Gas Permeation Property of Silicon Carbide Membranes Synthesized by Counter-Diffusion Chemical Vapor Deposition. Membranes 10, 11 (2020).
16. Hong, M., Falconer, J. L. & Noble, R. D. Modification of zeolite membranes for H2 separation by catalytic cracking of methyldiethoxysilane. Industrial & engineering chemistry research 44, 4035-4041 (2005).
17. Wang, H. & Lin, Y. Synthesis and modification of ZSM-5/silicalite bilayer membrane with improved hydrogen separation performance. Journal of membrane science 396, 128-137 (2012).
18. Nian, P. et al. ZnO nanorod-induced heteroepitaxial growth of SOD type Co-based zeolitic imidazolate framework membranes for H₂ separation. ACS applied materials & interfaces 10, 4151-4160 (2018).
19. De Vos, R. M. & Verweij, H. High-selectivity, high-flux silica membranes for gas separation. Science 279, 1710-1711 (1998).
20. Boffa, V., Blank, D. H. & ten Elshof, J. E. Hydrothermal stability of microporous silica and niobia-silica membranes. Journal of Membrane Science 319, 256-263 (2008).
21. Ding, L. et al. MXene molecular sieving membranes for highly efficient gas separation. Nature communications 9, 155 (2018).
22. Li, W. et al. Transformation of metal-organic frameworks for molecular sieving membranes. Nature communications 7, 11315 (2016).
23. Sun, Y., Song, C., Guo, X. & Liu, Y. Concurrent Manipulation of Out-of-Plane and Regional In-Plane Orientations of NH2-UiO-66 Membranes with Significantly Reduced Anisotropic Grain Boundary and Superior H2/CO2 Separation Performance. ACS Applied Materials & Interfaces (2019).
24. Wang, X. et al. Reversed thermo-switchable molecular sieving membranes composed of two-dimensional metal-organic nanosheets for gas separation. Nature communications 8, 14460 (2017).
25. Nian, P., Liu, H. & Zhang, X. Bottom-up fabrication of two-dimensional Co-based zeolitic imidazolate framework tubular membranes consisting of nanosheets by vapor phase transformation of Co-based gel for H2/CO2 separation. Journal of membrane science 573, 200-209 (2019).
26. Kang, Z. et al. Highly selective sieving of small gas molecules by using an ultramicroporous metal-organic framework membrane. Energy & Environmental Science 7, 4053-4060 (2014).
27. Li, Y. et al. Growth of ZnO self-converted 2D nanosheet zeolitic imidazolate framework membranes by an ammonia-assisted strategy. Nano Research 11, 1850-1860 (2018).
28. Huang, Y. et al. Ionic liquid functionalized multi-walled carbon nanotubes/zeolitic imidazolate framework hybrid membranes for efficient H₂/CO₂ separation. Chemical Communications 51, 17281-17284 (2015).
29. Li, Z. et al. A Robust Zeolitic Imidazolate Framework Membrane with High H2/CO2 Separation Performance under Hydrothermal Conditions. ACS applied materials & interfaces 11, 15748-15755 (2019).
30. Peng, Y., Li, Y., Ban, Y. & Yang, W. Two-Dimensional 1 Metal-Organic Framework Nanosheets for Membrane-Based Gas Separation. Angewandte Chemie International Edition 56, 9757-9761 (2017).
31. Peng, Y. et al. Metal-organic framework nanosheets as building blocks for molecular sieving membranes. Science 346, 1356-1359 (2014).Lu et al., Facile, Noncovalent Decoration of Graphene Oxide Sheets with Nanocrystals. Nano Res 2, 192 200 (2009).
32. Lu et al., Facile, Noncovalent Decoration of Graphene Oxide Sheets with Nanocrystals. Nano Res 2, 192 200 (2009).
33. Gacka et al., Noncovalent Porphyrin-Graphene Oxide Nanohybrids: The pH Dependent Behavior. J. Phys. Chem. C, 123, 3368-3380 (2019).
34. Xia et al., Superstrong Noncovalent Interface between Melamine and Graphene Oxide. ACS Appl. Mater. Interfaces 2019, 11, 17068-17078.
35. Mailer et al., Particle sizing by dynamic light scattering: non-linear cumulant analysis, arXiv:1504.06502v, 1-17.

1. A porous composite membrane comprising:
graphene oxide sheets; and
nanoparticles bound to a surface of the graphene oxide sheets solely by electrostatic and/or Van der Waals interactions.

2. The porous composite membrane of claim 1, wherein the composite membrane includes a plurality of stacked graphene oxide sheets, and the nanoparticles are intercalated between the stacks of graphene oxide sheets.

3. The porous composite membrane of claim 1, wherein the graphene oxide sheets have an average lateral size about 200 nm to 15 μm.

4. The porous composite membrane of claim 1, wherein the nanoparticles have an average diameter of about 3 to 10 nm.

5. The porous composite membrane of claim 1, wherein an amount of about 5 to 40% wt of nanoparticles are assembled on the graphene oxide sheet surface by electrostatic and/or hydrogen bond interactions; and the % wt being expressed based on the total weight graphene oxide sheets+nanoparticles.

6. The porous composite membrane of claim 1, wherein the nanoparticles have a positive charge of not less than 30 mV Zeta potentials at pH 7.

7. The porous composite membrane of claim 1, wherein the nanoparticles include nanodiamonds.

8. The porous composite membrane of claim 2, wherein at least a part of the interlayer distance between the stacks graphene oxide sheets is not more than 0.6 nm.

9. A method of manufacturing a porous composite membrane according to claim 1, comprising the steps of:
(i) providing a dispersion of graphene oxide sheets in an aqueous solvent;
(ii) providing a dispersion of nanoparticles in an aqueous solvent;
(iii) mixing the graphene oxide dispersion and the nanoparticle dispersion to form a dispersion of graphene oxide-nanoparticle composite; and
(iv) filtering the dispersion obtained in step (iii) through a porous support substrate to form a substrate-supported graphene oxide-nanoparticle composite membrane.

10. The method of claim 9, wherein the aqueous solvents in steps (i) and (ii) are one and the same aqueous solvent, selected from water or alcohol/water mixtures.

11. The method of claim 9, wherein the aqueous solvent in steps (i) and (ii) is water at pH=6-7.

12. A gas separation system comprising a porous composite membrane in fluidic communication with a gas stream containing a mixture of at least two separable gases including H2, wherein the porous composite membrane comprises:
graphene oxide sheets; and
nanoparticles bound to a surface of the graphene oxide sheets solely by electrostatic and/or Van der Waals interactions

13. The gas separation system of claim 12, wherein the porous composite membrane is disposed on a porous support substrate.

14. The gas separation system of claim 12, wherein the porous support substrate comprises a ceramic or polymeric porous support, including porous ceramic materials such as an alumina- or silica-based porous ceramic, and hydrophilic polymeric materials such as polysulfones (PS), polyethersulfones (PES), fluoropolymers such as polyvinylidene fluoride (PVDF) or polyacrylonitrile.

15. The gas separation system of claim 12, wherein the porous composite membrane:
(i) has a hardness ≥610 MPa, as measured using the nanoindentation method at 25±3° C. with a Berkovich three-sided pyramid diamond tip (radius of 100 nm) at the load of 0.05 mN, the errors of measurements being reported based on the standard error of 20 indents; and
(ii) has a Young's modulus ≥15 GPa, as measured using the nanoindentation method at 25±3° C. with a Berkovich three-sided pyramid diamond tip (radius of 100 nm) at the load of 0.05 mN, the errors of measurements being reported based on the standard error of 20 indents.

16. The gas separation system of claim 12, comprising:
a separator unit having an inlet, a retentate outlet, and a permeate outlet;
a gas stream in fluidic communication with the inlet of the separator unit, the gas stream comprising a mixture of at least two separable gases including at least H₂;
at least one porous composite membrane according to claim 1 configured within the separator unit such that only permeates can flow from the inlet to the permeate outlet after first passing through the porous composite membrane and such that retentates flow from the inlet to the retentate outlet without passing through the porous composite membrane;
a retentate collector in fluidic communication with the retentate outlet of the separator unit; and
a permeate collector in fluidic communication with the permeate outlet of the separator unit.

17. A process for separating H₂ from a gas stream, comprising a step of permeating a mixture of at least two separable gases through a porous composite membrane of claim 1, wherein the gas mixture comprises at least H₂.

18. A process for reducing H2O swelling in a graphene oxide-based hydrogen membrane comprising associating nanoparticles in electrostatically and/or Van der Waals binding interaction with graphene oxide sheets constituting the graphene oxide-based hydrogen membrane.
